(19) United States
(12) Patent Application Publication
(10) Pub. No.: US 2003/0202817 A1
(43) Pub. Date: Oct. 30, 2003

(54) Process cartridge and remanufacturing method therefor

(75) Inventors: Akira Higeta, Shizuoka-ken (JP); Satoshi Yasuda, Toride-shi (JP); Takayoshi Hoshi, Toride-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/207,870

(22) Filed: Jul. 31, 2002

(30) Foreign Application Priority Data
Apr. 26, 2002 (JP) 126157/2002 (PAT.

(51) Int. Cl. G03G 15/00

(52) U.S. Cl. 399/109

(57) ABSTRACT

A remanufacturing method for a process cartridge detachably mountable to a main assembly of an electrophotographic image forming apparatus, wherein the process cartridge comprises a first frame supporting an electrophotographic photosensitive drum and a second frame which supports a developing roller for developing an electrostatic latent image formed on the electrophotographic photosensitive drum and which includes a developer accommodating portion accommodating a developer to be used for development of the electrostatic latent image by the developing roller, wherein the first frame and the second frame are rotatably coupled relative to each other, the remanufacturing method including (a) a separating step of separating the first frame and the second frame from each other; (b) a developing roller dismounting step of dismounting the developing roller mounted in the second frame; (c) an elastic sealing member peeling step of peeling off an elastic sealing member for providing seal between the second frame and the developing roller, wherein the elastic sealing member has been stuck in a longitudinal direction of the second frame; (d) an elastic sealing member sticking step of sticking a double coated tape on a seat on which the elastic sealing member has been stuck in a widthwise direction of the seat such that it protrudes toward the developing roller and resticking an elastic sealing member using the double coated tape; (e) a developer filling step of filling the developer into the developer accommodating portion; (f) a developing roller mounting step of mounting a developing roller to a second frame; and (g) a frame coupling step of coupling separated first frame and second frame with each other.

### FIELD OF THE INVENTION AND RELATED ART

The present invention relates to a process cartridge and a remanufacturing method for the process cartridge The process cartridge is a cartridge or unit which contains as a unit at least an electrophotographic photosensitive drum and developing means (developing member) and which is detachably mountable to a main assembly of an electrophotographic image forming apparatus.

The electrophotographic image forming apparatus may be an electrophotographic copying machine, an electrophotographic printer (a LED printer, a laser beam printer or the like), an electrophotographic printer type facsimile machine, an electrophotographic printer type word processor or the like.

In an image forming apparatus using an electrophotographic image forming process, a process cartridge type in which an electrophotographic photosensitive member and process means actable on said electrophotographic photosensitive member are contained as a unit in a process cartridge which is detachably mountable to the main assembly of the image forming apparatus, has been used. The process cartridge type is advantageous in that maintenance operations can be performed not by a service person but by the user in effect, and therefore, operation property has been significantly improved. Therefore, the process cartridge type is widely used in the electrophotographic image forming apparatus.

The process cartridge forms an image on a recording material using a developer. Therefore, the developer is consumed with the image forming operation. When the developer is consumed up to such an extent that user is not satisfied with the image quality, the commercial value of the process cartridge is lost.

It is desired that such a used process is cartridge are is given the commercial value, again by remanufacturing the process cartridge through easy method.

### SUMMARY OF THE INVENTION

Accordingly, it is a principal object of the present invention to provide a simple remanufacturing method for a process cartridge.

It is another object of the present invention to provide a remanufacturing method of a process cartridge wherein the process cartridge with which the developer is consumed to such an extent that user is not satisfied with the image quality is recycled to be given the commercial value.

According to an aspect of the present invention, there is provided a remanufacturing method for a process cartridge detachably mountable to a main assembly of an electrophotographic image forming apparatus, wherein said process cartridge comprises a first frame supporting an electrophotographic photosensitive drum and a second frame which supports a developing roller for developing an electrostatic latent image formed on the electrophotographic photosensitive drum and which includes a developer accommodating portion accommodating a developer to be used for development of the electrostatic latent image by the developing roller, wherein said first frame and said second frame are rotatably coupled, said remanufacturing method comprising (a) a separating step or separating the first frame and the second frame from each other; (b) a developing roller dismounting step of dismounting the developing roller mounted in the second frame; (c) an elastic sealing member peeling step of peeling off an elastic sealing member for providing seal between the second frame and the developing roller, wherein said elastic sealing member has been stuck in a longitudinal, direction of the second frame; (d) an elastic sealing member sticking step of sticking a double coated tape on a seat on which the elastic sealing member has been stuck in a widthwise direction of the seat such that it protrudes toward the developing roller and resticking an elastic sealing member using the double coated tape; (e) a developer filling step of filling the developer into the developer accommodating portion; (f) a developing roller mounting step of mounting a developing roller to a second frame; and (g) a frame coupling step of coupling separated first frame and second frame with each other.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a longitudinal sectional view of an electrophotographic image forming apparatus.

FIG. 2 is a longitudinal sectional view of a process cartridge.

FIG. 3 is a perspective view of the process cartridge of FIG. 2 as seen from upper right.

FIG. 4 is a perspective view of the process cartridge of FIG. 2 as seen from upper left.

FIG. 5 is a perspective view of the process cartridge of FIG. 2 as seen from bottom left.

FIG. 6 is a perspective view of a mounting portion of a main assembly of the apparatus for the process cartridge.

FIG. 7 is a perspective view of a mounting portion of a main assembly of the apparatus for the process cartridge.

FIG. 8 is a longitudinal sectional view of a photosensitive drum and a driving device therefor.

FIG. 9 is a perspective view of a cleaning unit.

FIG. 10 is a perspective view of a developing unit.

FIG. 11 is a partly broken perspective view of a developing unit.

FIG. 12 is a perspective view of a rear portion of a development holder.

FIG. 13 is a side view of a side plate and a toner frame of a developing device frame.

FIG. 14 is a perspective view of a developing roller shaft reception box.

FIG. 15 is a perspective view of a developing device frame.

FIG. 16 is a perspective view of a toner frame.

FIG. 17 is a perspective view of a toner frame.

FIG. 18 is a longitudinal sectional view of a toner seal portion of FIG. 17.

FIG. 19 is a perspective view of a mounting portion of t photosensitive drum to the cleaning frame.

FIG. 20 is a longitudinal sectional view of a drum shaft receiving portion.

FIG. 21 is a side view showing a configuration of an outside of the drum shaft receiving portion.

FIG. 22 is a sectional side elevation illustrating a mounting step of a part in a remanufacturing process.

FIG. 23 is a top plan view illustrating a part mounting step in the remanufacturing process.

FIG. 24 is an enlarged view of an upper surface portion illustrating a mounting step of mounting a second developing roller one end portion assistance seal which is newly mounted on the remanufacturing process.

FIG. 25 is an enlarged view of an upper surface portion illustrating a sticking step of newly sticking a thin elastic sealing member in the remanufacturing process.

FIG. 26 is a top plan view illustrating sticking state of the thin elastic sealing member which is remounted in the remanufacturing process.

FIG. 27 is a top plan view of picked-up jaw portion and thin elastic sealing member.

FIG. 28 is a longitudinal sectional view illustrating a refilling step of toner.

FIG. 29 is a perspective view illustrating a cleaning operation for a cleaning frame.

FIG. 30 is a longitudinal sectional view of a process cartridge remanufactured by the present invention.

FIG. 31 is a perspective view of a developing blade to be used in a remanufactured process cartridge.

FIG. 32 is a longitudinal section enlarged view in which a thin elastic sealing member is wound.

### DETAILED DESCRIPTION OF THE PREFERRED EMBODIMENTS

Next, the preferable embodiments of the present invention will be described. In the following descriptions, the widthwise direction means the direction in which a process cartridge B is mounted into, or dismounted from, the apparatus main assembly 14. In coincides with the direction in which recording medium is conveyed. The lengthwise direction of the process cartridge B means the direction perpendicular (approximately perpendicular) to the direction in which the process cartridge B is mounted into, or dismounted from, the apparatus main assembly. Further, the left or right side of the process cartridge B means the left or right side as seen from above, from the downstream side in terms of the direction in which recording medium is conveyed.

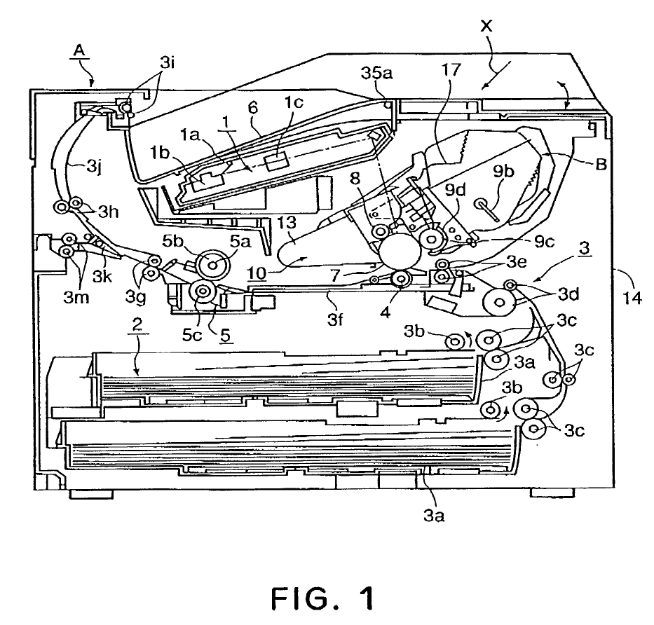

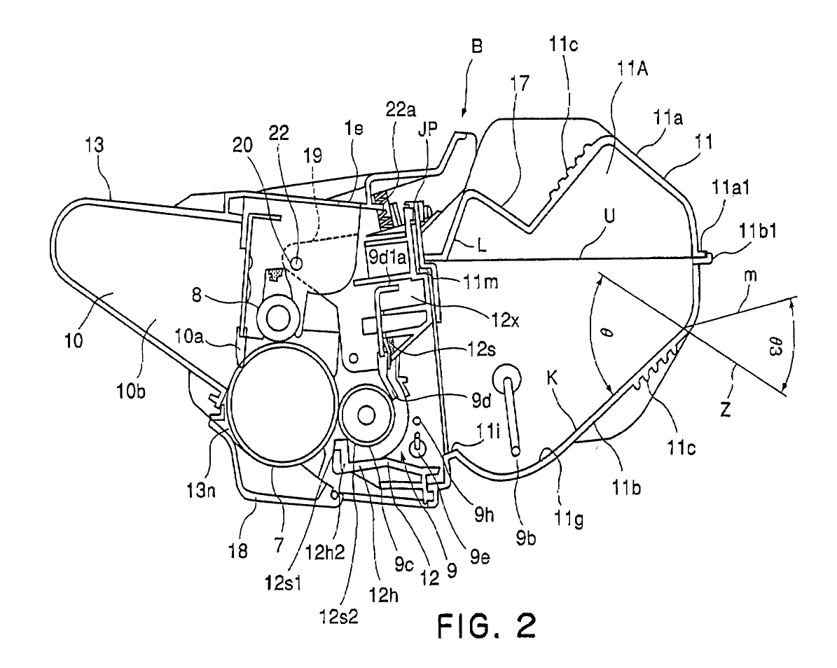

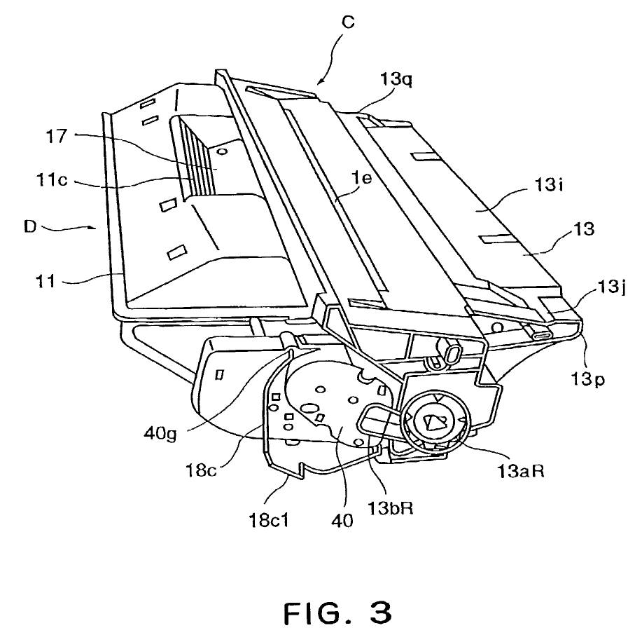

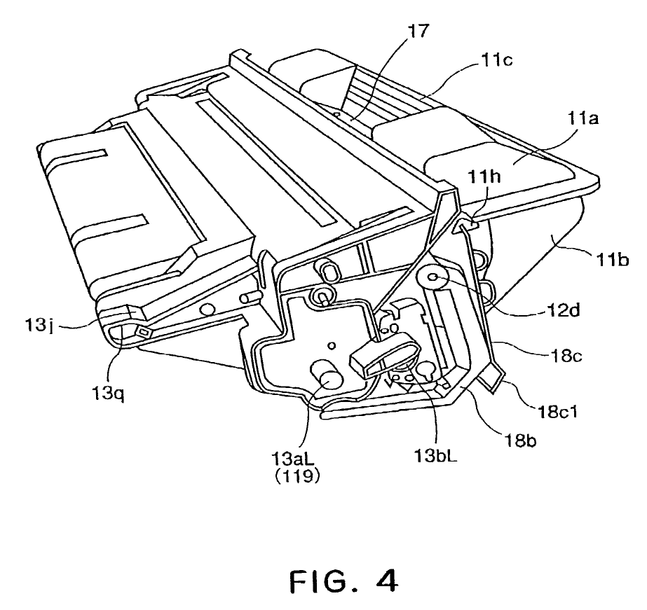

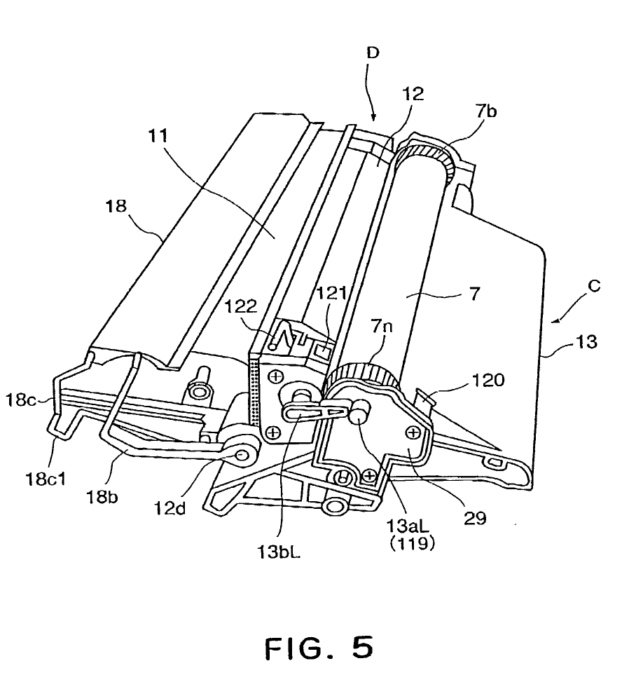

FIG. 1 is a sectional view of an electrophotographic image forming apparatus (laser beam printer) in accordance with an embodiment of the present invention, for depicting the structure thereof. FIGS. 2-5 are drawings of the process cartridge in the embodiment of the present invention. More specifically, FIG. 2 is a sectional view of the process cartridge, at a plane perpendicular to the lengthwise direction of the process cartridge, and FIG. 3 is an external perspective view of the process cartridge. FIG. 4 is a perspective view of the process cartridge as seen from diagonally above, and FIG. 5 is a perspective view of the process cartridge, as seen from diagonally above, with the process cartridge being positioned upside down. In the following description of the process cartridge, the top surface of the process cartridge means the external surface of the process cartridge, which faces upward when the process cartridge B is in the proper position in the apparatus main assembly 14, and the bottom surface is the external surface of the process cartridge B which faces downward when the process cartridge B is in the proper position in the apparatus main assembly 14.

First, referring to FIG. 1, a laser beam printer A as an example of an electrophotographic image forming apparatus to which this embodiment of the present invention is applicable will be described. As shown in FIG. 1, this laser beam printer A is an apparatus which forms an image on recording medium (for example, recording paper, OHP sheet, fabric, and the like) with the use of an electrophotographic image forming process. As for an image forming process, first, a toner image, that is, a visual image formed of developer (which hereinafter will be referred to as toner) is formed on an electrophotographic photoconductive member in the form of a drum (which hereinafter will be referred to as photosensitive drum). More specifically, first, the photoconductive drum is charged by a charging means, and then, is exposed to a beam of laser light projected from an optical means while being modulated with the image formation data. As a result, a latent image reflecting the image formation data is formed on the photoconductive drum. This latent image is developed by a developing means into a toner image. Meanwhile, in synchronism with the formation of the toner image, a recording medium 2 set in a cassette 3a is fed into the apparatus main assembly by a pickup roller 3b, a pair of conveying rollers 3c and 3d, and a registration roller pair 3e. During this feeding of the apparatus main assembly, the recording medium 2 is placed upside down. Next, the toner image on the photoconductive drum 7 is transferred onto the recording medium 2 by applying voltage to a transfer roller 4 as a transferring means. Thereafter, the recording medium 2 having received the toner image is conveyed to a fixing means 5 by a conveying guide 3f. The fixing means 5 has driving roller 5c and fixing roller 5b. The fixing roller 5b contains a heater 5a. In the fixing means S, heat and pressure are applied to the recording medium 2 as the recording medium 2 is passed through the fixing means 5. As a result, the toner image is fixed to the recording medium 2 Then, the recording medium 2 is farther conveyed by the discharge roller pairs 3g, 3h and 3i, and is discharged into a delivery tray 6 through the reversing path 3j. The delivery tray 6 is a part of the top surface of the main assembly of the image forming apparatus A. Incidentally, a pivotal flapper 3k may be pivoted so that the recording medium 2 is discharged by the discharge roller pair 3m, without being passed through the overturning path 3j. In this embodiment, the aforementioned pickup roller 3b, pair of conveying rollers 3c and 3d, registration roller pair 3e, conveying guide 3f, discharge roller pairs 3g, 3h, and 31, and discharge roller pair 3m make up a conveying means 3.

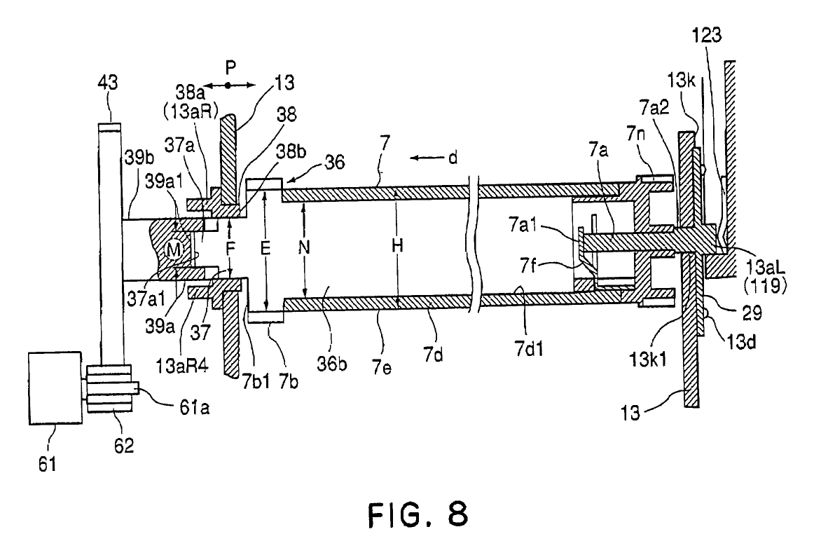

Referring to FIGS. 2-5, on the other hand, in the process cartridge B, the photoconductive drum 7, the peripheral layer of which is a photoconductive layer 7c (FIG. 8), is rotated, and the peripheral surface of the photoconductive drum 7 is uniformly charged by applying voltage to a charge roller 8 as a charging means. Next, a beam of laser light reflecting the image formation data is projected from an optical system 1 onto the photoconductive drum 7 through an exposure opening le. As a result, an electrostatic latent image is formed on the photoconductive drum 7. This latent image is developed by a developing means 9 which uses toner. More specifically, the charge roller 8 is placed in contact with the photoconductive drum 7, and electrically charges the photoconductive drum 7. The charge roller 8 is rotated by the rotation of the photoconductive drum 7. The developing means 9 supplies toner onto the region of the photoconductive drum 7, which is in the development station, so that the latent image on the photoconductive drum 7 is developed. The optical system 1 has a laser diode 1a, a polygonal mirror 1b, a lens 1c, and a deflective mirror 1d.

In the developing means 9, as the toner sending member 9 is rotated, the toner in the toner container 11A is sent out of the container 11A, and is delivered to the development roller 9c, which contains a stationary magnet and is being rotated. As a result, a layer of toner is formed on the peripheral surface of the development roller 9c while being triboelectrically charged by a development blade 9d. The toner particles in this toner layer are supplied onto the region of the photoconductive drum 7 in the development station. More specifically, the toner particles are transferred onto the peripheral surface of the photoconductive drum 7 in a pattern reflecting the latent image. As a result, a toner image is formed an the peripheral surface of the photoconductive drum 7. The development blade 9d is a member which regulates the amount by which toner is placed on the peripheral surface of the development roller 9c and also triboelectrically charges the toner. In the adjacencies of the development roller 9c, a Loner stirring member 9e for circulating the toner within the development chamber is rotatably disposed. The aforementioned toner image on the photoconductive drum 7 is transferred onto the recording medium 2 by applying electrical voltage, which is opposite in polarity to the toner image, to a transfer roller 4. Thereafter, the toner particles remaining on the peripheral surface of the photoconductive drum 7 are removed by a cleaning means 10. More specifically, the cleaning means 10 has an elastic cleaning blade 10a placed in contact with the peripheral surface of the photoconductive drum 7, and the toner particles remaining on the peripheral surface of the photoconductive drum 7 are scraped down by the cleaning blade 10a, being collected into a removed toner bin 10b. Incidentally, the cartridge B comprises a toner holding frame 11, which has the Loner container 11A (toner storage portion) for holding toner, and a developing means holding frame 12 which holds the developing means 9 such as a development roller 9c and the like. The toner holding frame 11 and developing means holding frame 12 are joined with each other, making up a second frame 200. The cartridge B also comprises a cleaning means holding frame 13 (first frame), to which photoconductive drum 7, cleaning means 10 such as the cleaning blade 10a, and the charge roller 8 are attached. The cleaning means holding frame 13 is joined with the frame 200. The cartridge B is removably mountable in the apparatus main assembly 14 by an operator. The cartridge B is provided with the exposure opening le for allowing a beam of light reflecting the image formation data to be projected onto the photoconductive drum 7, and a transfer opening 13n for placing the photoconductive drum 7 in contact with the recording medium 2. More specifically, the exposure opening 1e belongs to the cleaning means holding frame 13, whereas the transfer opening 13n is a gap formed between the developing means holding frame 12 and cleaning means holding frame 13.

{Structure of Housing of Process Cartridge B}

Next, the structure of the housing of the cartridge B in this embodiment will be described.

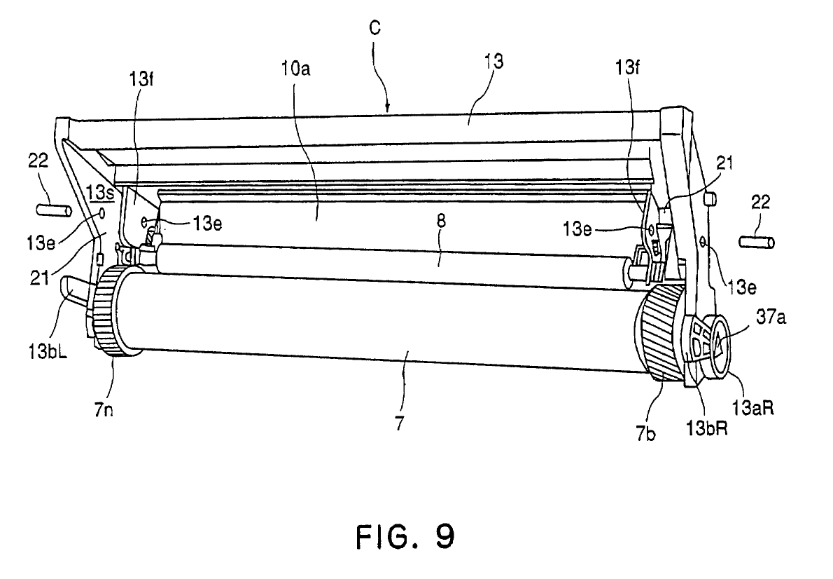

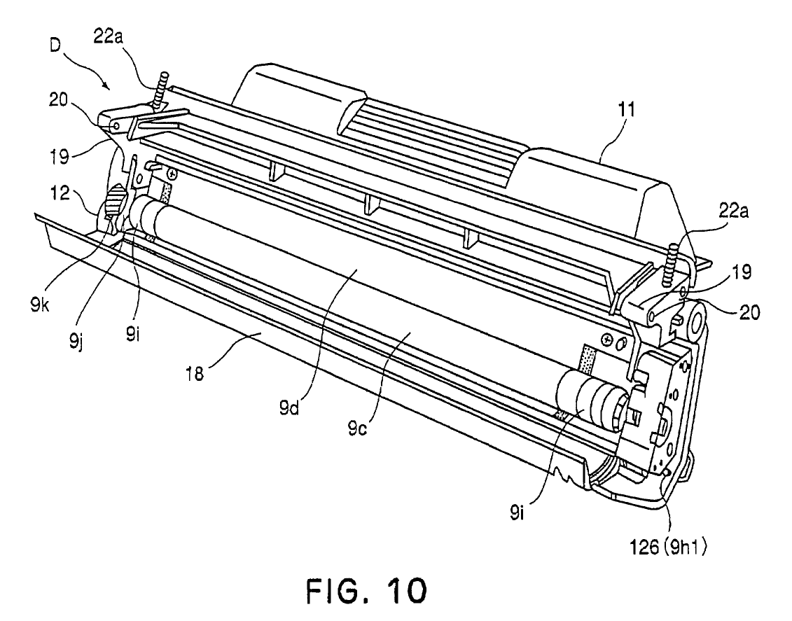

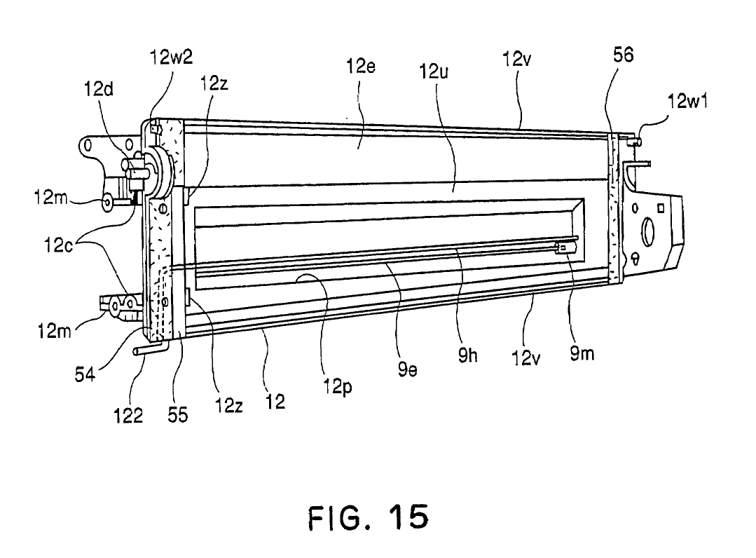

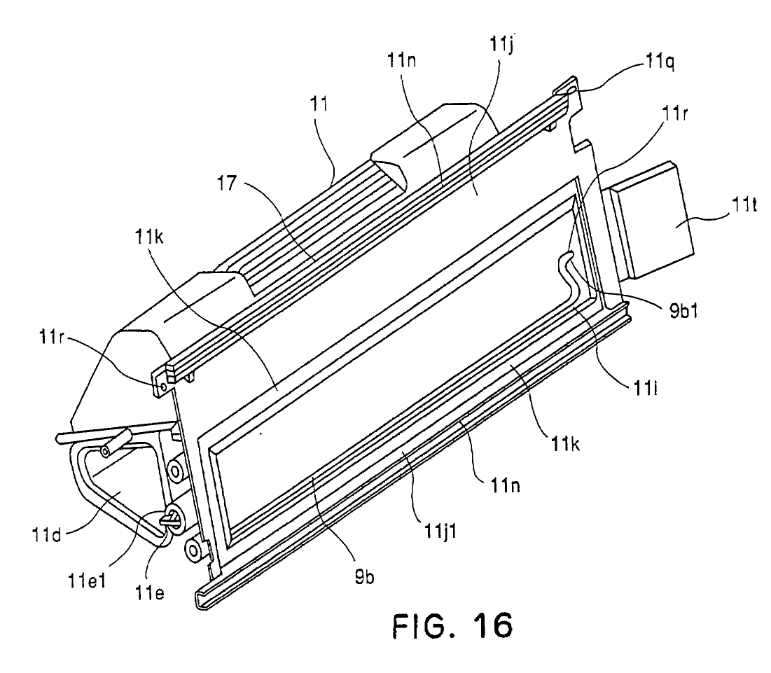

The cartridge B in this embodiment comprises the toner holding frame 11 and developing means holding frame 12, which are joined together, making up the second frame 200. To the second frame 200, the cleaning means holding frame 13 (first frame) is rotatably attached, in other words, the toner holding frame 11, developing means holding frame 12, and cleaning means holding frame 13 are joined as described above, making up the housing of the cartridge B. In the housing, the photoconductive drum 7, charge roller 8, developing means 9, cleaning means 9, and the like, are disposed, making up the cartridge B, which is enabled to be removably mountable into the cartridge mounting means of the apparatus main assembly 14. Next, the structures of these frames will be described in more detail. Referring to FIGS. 2 and 16, the toner holding frame 11 holds the toner sending member 9b, which is rotatably attached to the toner holding frame 11. To the developing means holding frame 12, the development roller 9c and development blade 9d are attached. Further, in the adjacencies of the development roller 9c, the stirring member 9c for circulating toner within the development chamber is rotatably attached to the developing means holding frame 12. Also to the developing means holding frame 12, a rod antenna 9h is attached, extending along the development roller 9c approximately in parallel to the lengthwise direction, as shown in FIGS. 2 and 15. The toner holding frame 11 and developing means holding frame 12 are welded (ultrasonic welding is used in this embodiment) to each other, forming a virtually monolithic second frame, which constitutes the development unit D (FIG. 10). To the development unit D, a drum shutter assembly 18 for covering the photoconductive drum 7 to prevent the photoconductive drum 7 from being exposed to the ambient light for an extended length of time and also from coming into contact with foreign substances, when the cartridge B is removed from the apparatus main assembly 14 or while it is out of the apparatus main assembly 14, is attached. Referring to FIG. 4, the shutter assembly 18 has a shutter 18a, which exposes or covers the transfer opening 18n (FIG. 2), and a pair of lines 18b and 18c for supporting the shutter 18a. On the upstream side of the cartridge B in terms of the recording medium 2 conveyance direction, one end of the right link 18c is fitted in the hole 40g of the developing means holder 40 as shown in FIG. 3, and one end of the left link 18c is fitted around the boss 11h of the bottom subframe 11b of the toner holding frame 11 as shown in FIG. 4 The other end of the link 18c is attached to the upstream side of the shutter 18a in terms of the cartridge mounting direction, whereas the other end of the link 18b is attached to the joggle 12d of the developing means holding frame 12. The ink 18c is provided with a projection 18cl, which is placed in contact with a solid anchoring portion (unshown) located next to the cartridge mounting space S of the apparatus main assembly 14. The shutter assembly 18 is moved by the movement of the cartridge B; the shutter 18a is opened by the movement of the cartridge B. This drum shutter assembly 18 is kept pressured by an unshown torsion coil spring in the direction to cause the shutter 18a to cover the opening 13n. Further, referring to FIGS. 2 and 9, to the cleaning means holding frame 13, the photoconductive drum 7, charging roller 8, and cleaning means 10, are attached, making up the first frame, which constitutes the cleaning unit C (FIG. 9).

The development unit D and cleaning unit C are joined with each other with the use of a pair of round pins 22, that is, connecting members, being enabled to pivot relative to each other, and making up the cartridge B. More specifically, referring to FIG. 10, the developing means holding frame 12 is provided with a pair of arms 19, which are located at the lengthwise ends (in terms of the direction of the axial line of the development roller 9c), one for one. The end portion of each arm 19 is provided with a round hole 20, which is parallel to the development roller 9c. On the other hand, the cleaning means holding frame 13 is provided with a pair of recesses 21, which are located at the lengthwise ends one for one (FIG. 9). The arm 19 is inserted into the corresponding recess 21. With the arm 19 being held in the recess 21, a connecting member 22 is pressed into the hole 13e of the frame 13, on the outward side of the cartridge B, is put through the hole 20 of the arm 19, and is inserted into the hole 13e of the frame 13, on the inward side of the cartridge B. As a result, the units D and C are connected to each other, being enabled to pivot relative to each other about the connecting members 22. With the two units attached to each other as described above, a pair of compression coil springs 22a fitted, one for one, around a pair of joggles (unshown) projecting from the adjacencies of the bases of the arm 19 remain in contact with the top walls of the recesses 21 and of the frame 13, keeping the developing means holding frame 12 pressed downward by their resiliency, ensuring thereby that the development roller 9c is kept pressed upon the photoconductive drum 7. More precisely, referring to FIG. 10, the lengthwise end portions of the development roller 9c are fitted with a spacer ring 9i, which is greater in diameter than the development roller 9c, and these spacer rings 9i are kept pressed upon the photoconductive drum 7 by the pair of compression coil springs, maintaining a predetermined gap (approximately 300 μm) between the peripheral surfaces of the photoconductive drum 7 and development roller 9c. In other words, the units D and C are pivotal relative to each other about the connecting members 22, and the positional relationship between the peripheral surfaces of the photoconductive drum 7 and development roller 9c is kept constant by the resiliency of the pair of compression coil springs 22a.

{Structure of Means for Guiding Process Cartridge B}

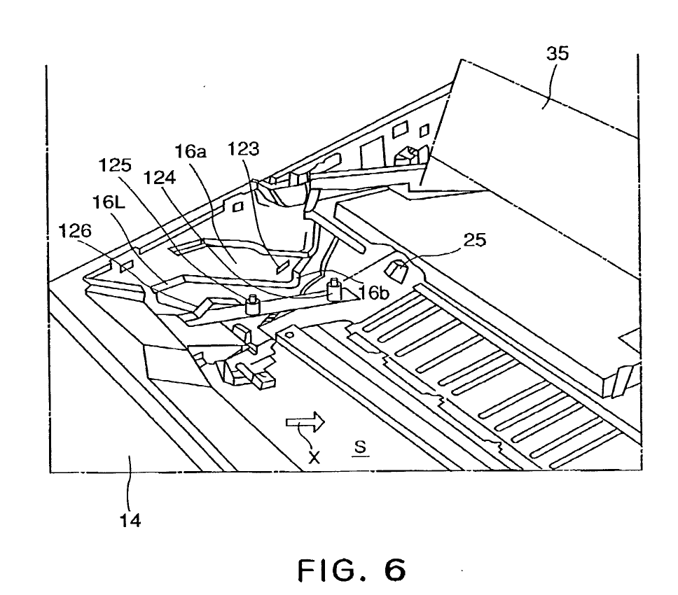

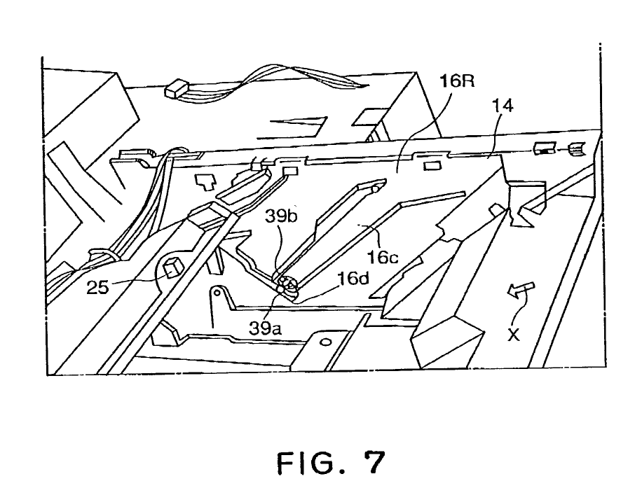

Next, the guiding means for guiding the process cartridge B when mounting the process cartridge B into the apparatus main assembly 14, or dismounting it therefrom, will be described. The guiding means is shown in FIGS. 6 and 7. FIG. 6 is a perspective view of the left portion of the process cartridge mounting space of the apparatus main assembly 14, as seen from the upstream side in terms of the direction (indicated by arrow mark X) in which the process cartridge B is inserted into the apparatus main assembly 14 (as seen from the development unit D side), whereas FIG. 7 is a perspective view of the right portion of the process cartridge mounting space as seen also from the upstream direction.

Next, referring to FIGS. 3 and 4, each of the lengthwise end surfaces of the above described frame 13 is provided with a guiding means which serves as a guide during the mounting or dismounting of the cartridge B, into or out of, the apparatus main assembly 14. The right and left guiding means are provided with a pair of cylindrical guides 13aR and 13aL, respectively, as guiding members, for positioning the cartridge B, and a pair of rotation controlling guides 13bR and 13bL, as guiding members, for controlling the attitude of the cartridge B during the amounting or dismounting of the cartridge B, into or out of, the apparatus main assembly 14. The guide 13bR is an integral part of the guide 13aR, and extends from the peripheral surface of the guide 13aR in the radius direction of the guide 13aR The guides 13aR and 13aL are fixed to the frame 13 with the use of screws. The guides 13aL and 13bL, which are integral parts of the frame 13, project from the lengthwise left end surface of the frame 13 in the direction perpendicular to the lengthwise left end surface. The guide 13bL is disposed slightly away from the guide 13aL, and the direction in which the guide 13bL extends in terms of the widthwise direction of the cartridge B approximately coincides with the radius direction of the guide 13aL.

Next, the rotation regulating contact areas 13j of the top surface 13i of the unit C will be described. Here, the top surface means the external surface of the cartridge B, which faces upward when the cartridge B is in the proper position in the apparatus main assembly 14. Referring to FIGS. 3 and 4, the top surface of the cartridge B in this embodiment is the top surface 13i of the unit C, and these are two rotation regulating contact areas 13j, one constituting a part of the right end portion 13p of the top surface 13i in terms of the direction perpendicular to the cartridge mounting direction, and the other constituting a part of the left end portion 13q of the top surface 13i. Each of the two contact areas 13j is an area which positions the cartridge B as the cartridge B is mounted into the apparatus main assembly 14. More specifically, as the cartridge B is mounted into the apparatus main assembly 14, the contact area 13j comes into contact with a solid cartridge catching member 25 (FIGS. 6 and 7) of the apparatus main assembly 14, controlling the rotational movement of the cartridge B about the guides 13aR and 13aL.

Next, the cartridge guiding means on the apparatus main assembly 14 side will be described. A lid 35 of the apparatus main assembly 14 is rotated counterclockwise about the hinge 35a (FIG. 1), exposing the top portion of the internal space of the apparatus main assembly 14, or the cartridge mounting space, which appears as shown in FIGS. 6 and 7. The let and right internal walls (FIGS. 6 and 7, respectively) of the cartridge mounting space, as seen from the cartridge mounting direction, which can be seen through the opening exposed by the opening of the lid 35, are provided with guiding members 16R and 16L, respectively. As is evident from the drawings, the guiding members 16R and 16L are provided with tilted guiding portions 16a and 16c, and positioning grooves 16b and 16d connected to the lower ends of the tilted guiding portions 16a and 16c, respectively. The aforementioned guides 13aR and 13aL fit into the positioning grooves 16b and 16d, respectively. The grooves 16b and 16d are semicylindrical, and when the cartridge B is in the proper position in the apparatus main assembly 14, the axial lines of the grooves 16b and 16d coincide with the axial lines of the guides 13aR and 13aL, coinciding therefore with the axial line of the drum 7. The rotation controlling guides 13aR and 13bL, the width of which are less than the diameters of the guides 13R and 13aL, respectively, loosely fit in the guiding portions 16c and 16d. However, with the guides 13aR and 13aL, and guides 13bR and 13bL, being fitted in the guiding portions 16a and 16c, the cartridge B is prevented from rotating about the axial lines of the guides 13aR and 13aL, and therefore, the attitude of the cartridge B is maintained in a predetermined range. Further, in the final stage of the mounting of the cartridge B into the apparatus main assembly 14, the guides 13aR and 13aL fit into the grooves 16b and 16d, respectively, and the contact areas 13j come into contact with the corresponding solid cartridge catching members 25.

In order to mount the cartridge B into the apparatus main assembly 14, first, an operator, or a user, is to insert the guides 13aR and 13aL into the guiding portions 16a and 16c, respectively, by grasping the cartridge B by one hand, with the fingers placed in the recess 17 of the toner holding frame 11, and on the ribs 11c on the bottom surface of the toner holding frame 11. Next, the guides 13bR and 13bL are to be inserted into the guiding portions 16a and 16b, respectively, with the cartridge B downwardly tilted in terms of the cartridge mounting direction. As a result, the guides 13aR and 13aL, and the guides 13bR and 13bL, advance inward following the guiding portions 16a and 16c, respectively. Then, as the guides 13aR and 13aL reach the grooves 16b and 16d, they settle in the grooves 16b and 16d, respectively, due to the weight of the cartridge B, being thereby accurately positioned relative to the grooves 16b and 16d, respectively. As a result, the photoconductive drum 7 is almost perfectly positioned relative to the apparatus main assembly 14; eventually, the photoconductive drum 7 is perfectly positioned relative to the apparatus main assembly 14 as the coupling on the photoconductive drum 7 side engages with the coupling on the apparatus main assembly 14 side. At this point in the cartridge inserting process, the operator is to release the cartridge B from the hand which is holding the cartridge B. As the cartridge B is released, the contact areas 13j come into contact with the corresponding solid cartridge catching members 25, accurately positioning the cartridge B relative to the apparatus main assembly 14 Thereafter, the lid 35 is to be closed.

All that is necessary to remove the cartridge B from the apparatus main assembly 14 is to carry out in reverse the above described cartridge mounting process.

{Toner Holding Frame}

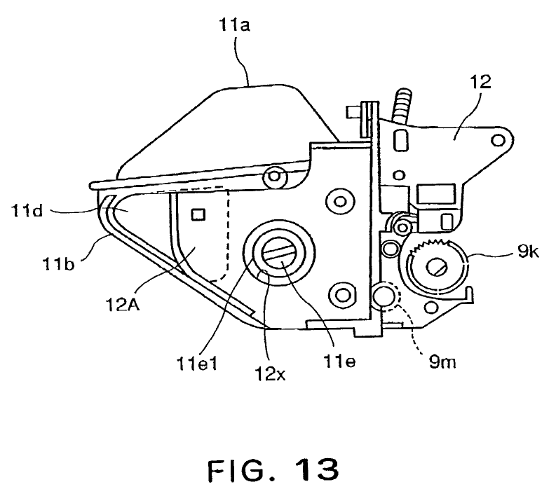

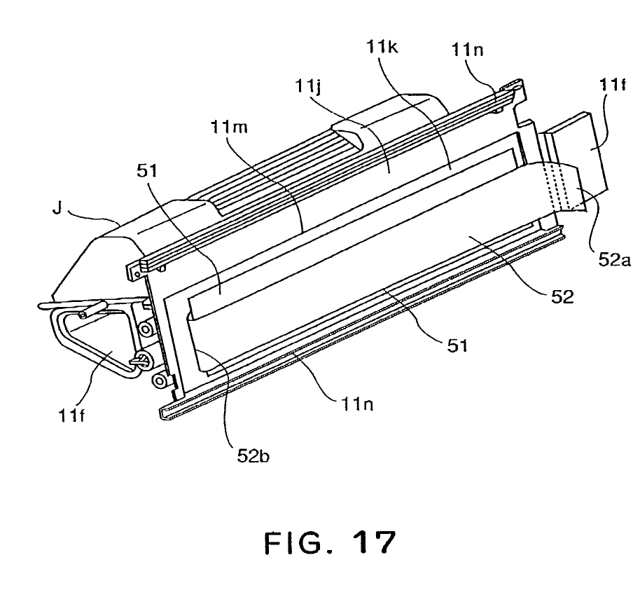

Referring to FIGS. 2, 4, 13, 16 and 17, the toner holding frame 11 will be described in detail (hereinafter, developer will be referred to as toner). FIG. 16 is a perspective view of the toner holding frame 11 prior to the welding of a toner seal, and FIG. 17 is a perspective view of the toner holding frame 11 after the filling of the toner holding frame 11 with toner. Referring to FIG. 2, the toner holding frame 11 is made up to two sections; a top sub-frame 11a and a bottom sub-frame 11b, which are provided with flanges 11a1 and 11b1. The top and bottom sub-frames 11a and 11b are joined at a welding surface U, which is the interface between the flanges 11a1 and 11b1; they are welded into the virtually monolithic toner holding frame 11 by ultrasonic welding. When welding the sub-frames 11a and 11b to each other, the two sub-frames 11a and 11b are supported by the flange 11b1. The toner holding frame 11 is provided with a stepped portion 11m, the riser portion of which is virtually level with the flange 11b1. Prior to the joining of the two sub-frames 11a and 11b, the toner sending member 9b is to be attached to the interior of the bottom sub-frame 11b. Next, referring to FIG. 13, the coupler assembly 11e is attached to one of the lengthwise ends of the toner sending member 9b through a hole 11e1 in one of the lengthwise end plates of the toner holding frame 11. The lengthwise end plate having the hole 11e1 is provided with a hole lid through which toner is fitted into the toner holding frame 11, and which is in the form of a virtually equilateral triangle. Next, referring to FIG. 16, the toner holding frame 11 is provided with a rectangular hole 11i, the lengthwise direction of which corresponds to the lengthwise direction of the toner holding frame 11, and through which toner is sent from the toner holding frame 11 to the developing means holding frame 12. The aforementioned seal (which will be described later) is welded to the edge of this hole 11i in a manner to seal the opening 11i. Thereafter, the toner is fitted into the toner holding frame 11 through the toner filling hole 11d. Then, the toner filling hole lid is plugged with a toner cap 11f as shown in FIG. 17, completing the toner unit J. The unit J is welded to the developing means holding frame 12, which will be described later, by ultrasonic welding, completing the development unit D.

Also referring to FIG. 2, the portion of the bottom sub-frame 11b below the toner sending member 9b is bulged outward, creating a recessed portion 11g, in order to prevent the bottom sub-frame 11b from introducing into the rotational range of the toner sending member 9b.

Referring to FIG. 16, the toner sending member 9b is shaped like a crank. One of its journal portions 9b1 of the toner sending member 9b is fitted in a hole 11r of the toner holding frame 11, and the other is fixed to the coupling assembly 11e (joint between toner sending member and coupling assembly is not visible in FIG. 16).

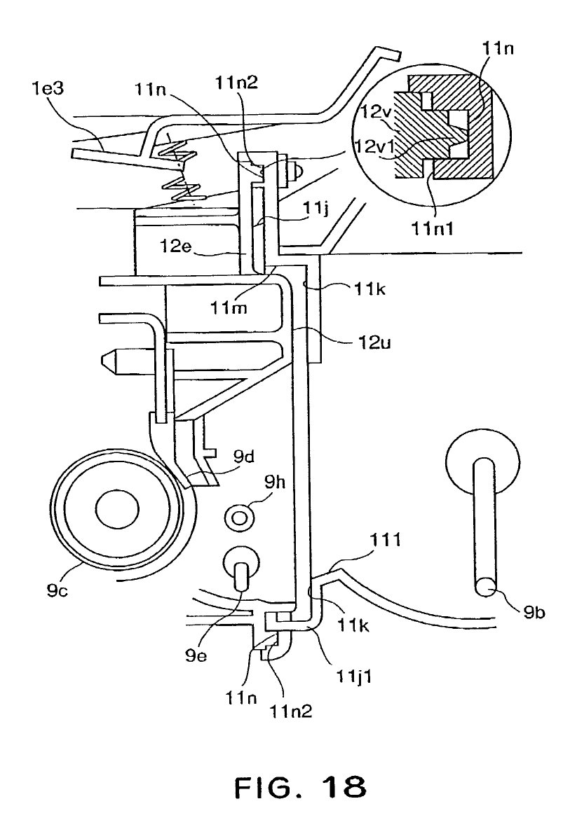

Further, the toner holding frame 11 is provided with a recessed surface 11k, which surrounds the above described rectangular hole 11i. The toner holding frame 11 is also provided with top and bottom flanges 1i and 11j1, and a groove 11n, which are parallel to each other, and are located in the adjacencies of the hole 11i. Referring to FIG. 18, the bottom surface 11n2 of the groove 11n of the toner holding frame 11 is positioned on the outward side (on the developing means holding frame 12 side), relative to the recessed surface 11k.

Referring to FIG. 15, the developing means holding frame 12 faces the toner holding frame 11 by a flat surface 12u, and has a flange 12e, which is positioned on the inward side relative to the flat surface 12. The developing means holding frame 12 also has a rib 12v, which fits into the groove 11n. The rib 12v extends along the flange 12c. It is provided with a rib 12v1, which is used for ultrasonic welding (FIG. 18). After the above described various components are attached to the interiors of the corresponding frames, the toner holding frame 11 and developing means holding frame 12 are put together, with the rib 11v fitted in the groove 11n, and are joined to each other by ultrasonic welding. As a result, the two frames 11 and 12 are welded to each other by their long edges. Referring to FIG. 17, the hole 11i is blocked with a cover film 51 pasted to the recess surface 11k; more specifically, the four edges of the film 51 arc pasted to the four edges, one for one, of the hole 11i of the toner holding frame 11. Further, the film 51 is provided with a tear tape 52, which is welded to the film 51 to expose the hole 11i, in other words, to tear the film 51. The tear tape 52 is extended from one of the lengthwise ends of the hole 11i (which corresponds to portion 52b) to the other end, is doubled back therefrom to the first end of the hole 11i, is extended beyond the first end of the hole 11i, and is extended outward between an elastic sealing member 54 formed of material such as felt, and the toner holding frame 11. The portion 52a of the tape 52 extending outward from the toner holding frame 11 is provided with a handle 11f (FIGS. 16 and 17). On the immediately inward side of the sealing member 54, there is a tape 55 formed of synthetic resin film. The tape 55 is pasted to the developing means holding frame 12. Further, there is another elastic sealing member 56, which is pasted to the flat surface of the flange 12e located opposite to the side to which the sealing member 54 is pasted, in terms of the lengthwise direction of the cartridge B (FIG. 15).

The above described elastic sealing members 54 and 56 are pasted to the lengthwise end portions of the flange 12e, extending across the entire width of the flange 12e. Further, the positions of the sealing members 54 and 56 coincide with those of the positions of the flanges 11j at the lengthwise ends of the recessed surface 11k, one for one, and are long enough to reach from one end of the flange 11j to the other, in terms of the widthwise direction, and extend farther to overlap with the rib 12v. Further, in order to make it easier to align the toner holding frame 11 and developing means holding frame 12 when joining the two frames, the flange 11j is provided with holes 11r and 11q, into which the joggles 12w1 and 12w2 of the developing means holding frame 12 fit.

Before joining the toner holding frame 11 and developing means holding frame 12 with each other, they are assembled as modules, independently from each other. When joining them thereafter, the joggles 12w1 and 12w2 are fitted into the holes 11r and 11q, respectively, and the rib 12v is fitted into the groove 11n. Then, the toner holding frame 11 and developing means holding frame 12 are pressed against each other. As they are pressed against each other, the sealing members 54 and 56 come into contact with the flange 11j, being thereby compressed, and a pair of ribs 12z, which are located on the lengthwise ends of the flat surface 12u of the developing means holding frame 12 and extend in the widthwise direction of the developing means holding frame 12, come close to the flange 11j. Here, in order to allow the tear tape 52 to pass, the pair of ribs 12z are positioned, one for one, at the widthwise ends of the flat surface 12u.

With the toner holding frame 11 and developing means holding frame 12 kept pressed against each other as described above, ultrasonic vibrations are applied to the interface between the surfaces of the rib 12v and grooves 11n to weld the rib 12v1 to the bottom surface of the groove 11n by melting the rib 12v1 with frictional heat. As a result, the edge 11n1 of the groove 11n, and the pair of ribs 12z, come into contact with each other, leaving a space between the recessed surface 11k of the toner holding frame 11, and the flat surface 12u of the developing means holding frame 12. The cover film 51 and tear tape 52 fit in this space. In order to send the toner in the toner holding frame 11 out into the developing means holding frame 12, an operator is to pull the aforementioned handle 11t by hand after breaking off the aforementioned handle lit attached to the end portion 52a of the tear tape 52 extending outward from the cartridge B, from the toner holding frame 11. As the handle 11t is pulled, the cover film 51 is torn, exposing the opening 11i. As a result, it becomes possible for the toner to be sent from the toner holding frame 11 to the developing means holding frame 12. The sealing members 54 and 56 located at the lengthwise ends of the flange 11j, one for one, have been compressed only in their thickness direction, keeping the development unit D satisfactorily sealed.

In FIG. 2, which is a sectional view of the toner holding frame 11 in this embodiment, at a plane perpendicular to the lengthwise direction of the cartridge B, the plane of the joint JP between the toner holding frame 11 and developing means holding frame 12 is approximately vertical.

Next, the toner holding frame 11 in this embodiment will be described further in detail. In order to allow the single-component toner in the toner container 11A to efficiently fall toward the opening 11i, the toner holding frame 11 is provided with two tilted surfaces K and L, which extend from one lengthwise end of the toner holding frame 11 to the other. The tilted surface L is located above the opening 11i, whereas the tilted surface K is on the rear side of the toner holding frame 11 as seen from the opening 11i side (in terms of the widthwise direction). Further, the tilted surface L is a part of the wall of the top sub-frame 11a, whereas the tilted surface K is a part of the wall of the bottom sub-frame 11b. With the cartridge B properly set in the apparatus main assembly 14, the tilted surface L is vertical, or the angle of the tilted surface L relative to the vertical direction is such that the tilted surface L faces diagonally downward. Further, the angle θ3 of the tilted surface K relative to the line perpendicular to the plane JP of the interface between the toner holding frame 11 and developing means holding frame 12 is approximately within the range of 20-40 deg. In other words, in this embodiment, the sub-frame 11a is shaped so that when attaching the sub-frame 11b to the sub-frame 11a, the sub-frame 11b is positioned at the above described angle. Therefore, according to this embodiment, the toner container 11A containing toner is enabled to efficiently move the toner toward the opening 11i.

[Developing Means Holding Frame]

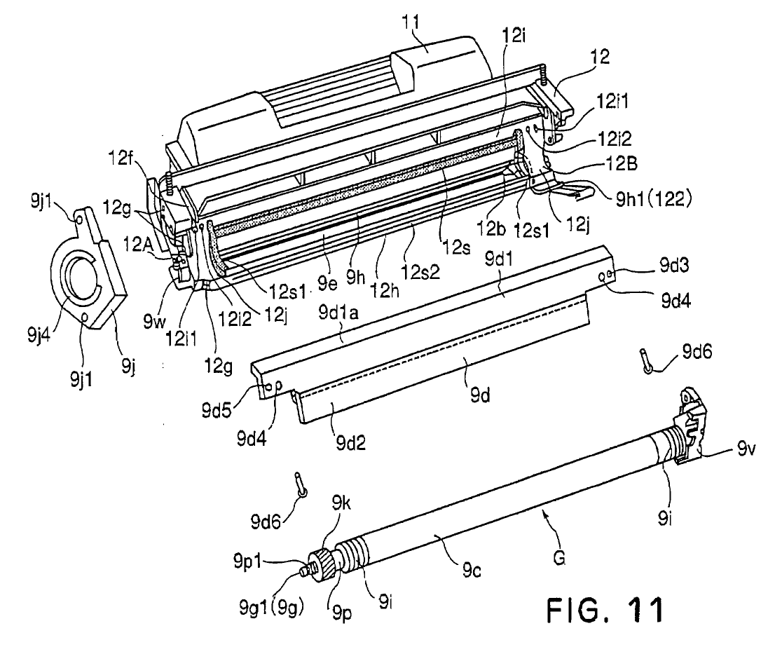

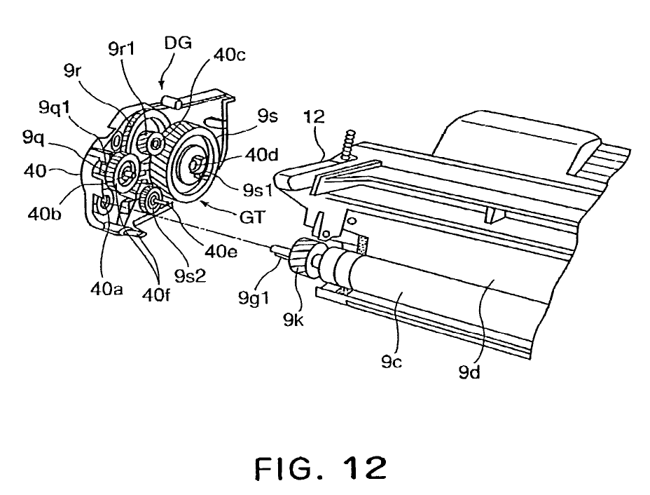

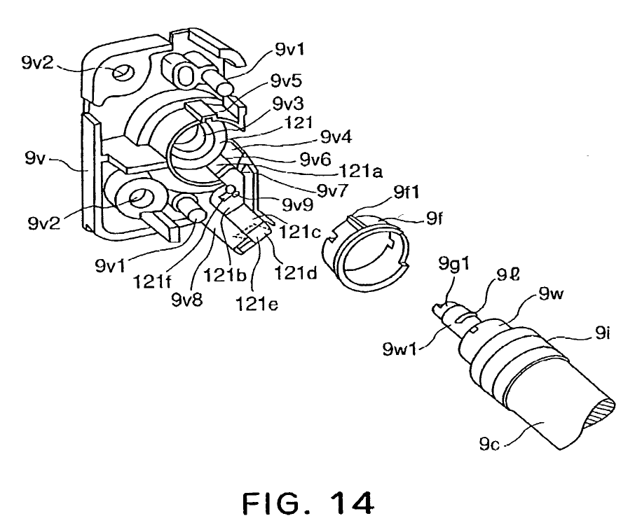

Next, referring to FIGS. 2, 11, 12, 13 and 14, the developing means holding frame 12 will be further described in detail. FIG. 11 is a perspective drawing for showing how various components are assembled into the developing means holding frame 12, and FIG. 12 is a perspective drawing for showing how a unit DG for transmitting driving force to the development station is attached to the developing means holding frame 12. FIG. 14 is a perspective drawing for showing the interior of the bearing box.

Into the developing means holding frame 12, the development roller 9c, development blade 9d, toner stirring member 9e, and rod antenna 9h for detecting the amount of the remaining toner, are assembled as described before. Referring to FIG. 11, the blade 9d is made up of a piece of 1-2 mm thick metallic plate 9d1, and a silicone rubber portion 9d2 molded onto the metallic plate 9d1. The amount by which toner is coated on the peripheral surface of the development roller 9c is regulated by positioning the rubber portion 9d2 to that it is placed in contact with the generatrix of the roller 9c. The lengthwise end portions of the flat surface 12i of the developing means holding frame 12, as a blade anchoring portion, are each provided with a joggle 12i1 and a screw hole 12i2. On the other hand, the right end portion of the metallic plate 9d1 is provided with a hole 9d3, and the left end portion of the metallic plate 9d1 is provided with a long hole 9d5 elongated in the lengthwise direction of the cartridge B. Into these holes 9d3 and 9d5, the above described pair of joggles 12i1 fit one for one. The pair of joggles 12i1, hole 9d3, and elongated hole 9d5, constitute a means for positioning the development blade 9d. More specifically, referring to the right-hand side of FIG. 11, the play between the walls of the joggle 12i1 and hole 9d3 is several microns to several tens of microns; in other words, the joggle 12i1 virtually perfectly fits in the hole 9d3, positioning the development blade 9d in terms of both the widthwise and Lengthwise directions. On the other hand, the left-hand joggle 12i1 is virtually identical to the right-hand joggle 12i1, whereas the hole 9d5 of the metallic plate 9d1, into which the left-hand joggle 12k1 fits, is elongated in the lengthwise direction of the cartridge B. Thus, in terms of the lengthwise direction, the development blade 9d is positioned as the joggle 12i1 is fitted into the hole 9d3, whereas in terms of the widthwise direction, the development blade 9d is positioned as the left- and right-hand joggles 12i1 are fitted into the holes 9d3 and 9d5 one for one. Therefore, the blade 9d can be accurately attached. With the blade 9d positioned by the above described positioning means, a pair of small screws 9d6 are put through a pair of screw holes 9d4 of the metallic plate 9d1, and are screwed into the pair of female-threaded holes 12i2 of the developing means holding frame 12, so that the metallic plate 9d1 is secured to the flat surface 12i. The developing means holding frame 12 is provided with an elastic sealing member 12s as a development blade long edge seal, a pair of magnetic sealing members 12s1 as development roller end seals, and an elastic sealing member 12s2. The elastic sealing member 12s is for scaling between the developing means holding frame 12 and development blade 9d to prevent toner from leaking outward, and is formed of Moltprene or the like. Its length is virtually the same as that of the metallic plate 9d1, and is pasted to the developing means holding frame 12 so that it extends in the lengthwise direction of the cartridge B, along the area which corresponds to the top edge of the metallic plate 9d1. The magnetic sealing member 12s2 is for sealing the corresponding lengthwise end of the development roller 9c. Each magnetic sealing member 12s2 extends downward from the corresponding lengthwise end of the sealing member 12s, following the arcuate surface 12f of the developing means holding frame 12, the curvature of which matches that of the development roller 9c, to the bottom end of the arcuate surface 12f. The elastic sealing member 12s2 is for sealing between the developing means holding frame 12 and development roller 9c, and is relatively thin. It is pasted to the mandible-like portion 12h of the developing means holding frame 12, being place in contact with the development roller 9c, with the surface of the elastic sealing member 12s2 in contact with the development roller 9c being tangential to the peripheral surface of the development roller 9c. In terms of the cross section perpendicular to the lengthwise direction, the metallic plate 9d1 of the development blade 9d is bent approximately 90 deg., forming a portion 9d1a.

Next, referring to FIGS. 11 and 14, the development roller unit G will be described. The development roller unit G comprises (1) development roller 9c and (2) a pair of spacer rings 9i for keeping constant the distance between the peripheral surfaces of the development roller 9c and photoconductive drum 7. The rings 9i are formed or electrically insulative synthetic resin. Each ring 9i doubles as a sleeve cap which covers the lengthwise end of the development roller 9c to prevent the electrical leak between the aluminum cylindrical portion of the photoconductive drum 7 and the aluminum cylindrical portion of the development roller 9c. The unit G also comprises; (3) development roller bearing 9j (enlarged in FIG. 11) for rotationally supporting the development roller 9c to position the development roller 9c relative to the developing means holding frame 12; (4) development roller gear 9k (helical gear) for rotating the development roller 9c by receiving driving force from a helical drum gear 7b (FIG. 8) attached to the photoconductive drum 7; (5) development contact 9l in the form of a coil spring (FIG. 14), one end of which is fitted around the end portion of the development roller 9c; and (6) magnet 9g positioned inside the development roller 9c to adhere Loner onto the peripheral surface of the development roller 9c. In FIG. 11, the bearing box 9v has already been attached to the unit G. However, the unit G is to be joined with the bearing box 9v when the bearing box 9v is attached to the lateral plate 12B of the developing means holding frame 12.

Also referring to FIG. 11, the unit G comprises a metallic flange 9p securely attached to one of the lengthwise end of the roller 9c. The flange 9p is provided with a roller gear attachment shaft 9p1, which projects outward in the lengthwise direction. A shaft portion 9p1 is cylindrical except for the double-flatted portion. The aforementioned development roller gear 9k formed of synthetic resin is fitted around the shaft portion 9p1, being prevented from rotating around the shaft portion 9p1 by the double-flatted portion. The gear 9k is a helical gear, with its teeth twisted in such a direction that as it is rotated, it pushes the development roller 9c toward the center of the roller 9c. Through this flange 9p, the D-cut shaft 9g1 of the magnet 9g protrudes outward, whereas the shaft 9g1 on the other end of the magnet 9g is fitted in the developing means holder 40 of the driving force transmission unit DG, which will be described later, being nonrotationally supported. The bearing 9j is provided with a round hole, the wall of which has a rotation control projection 9j5 projecting toward the axial line of the hole. Into this hole, a C-shaped bearing 9j4 is fitted. The aforementioned flange 9p is rotationally fitted in this bearing 9j4. The bearing 9j is fitted into the slit 12f of the developing means holding frame 12, and the projection 40f of the developing means holder 40 is inserted into the hole 12g of the developing means holding frame 12 and the hole 9j1 of the bearing 9j. As a result, the holder 40 is secured to the developing means holding frame 12, supporting the magnet 9g The wall of the hole into which the bearing 9j4 is inserted has a stepped portion, and the aforementioned projection 9j5 protrudes from the wall of the large diameter portion of the hole, into which the flange portion of the bearing 9j4 is fitted. The bearing 9j, and a bearing 9f which will be described later, are formed of polyacetals, polyamide, or the like.

The lengthwise end portions of the magnet 9g protrude from the corresponding ends of the development roller 9c. One end 9g1 of the magnet 9g is fitted in the supporting hole 9v3 of a box 9v (FIG. 14). Thc development roller 9c is provided with a hollow journal 9w, which is fitted within the end portion of the development roller 9e, being in contact with the internal wall of the development roller 9c. The hollow journal 9w is formed of insulating substance. The cylindrical portion 9w1, which is an integral part of this journal 9w, insulates between the development bias contact 9l, in the form of a coil spring, electrically connected to the development roller 9c, and the magnet 9g. The bearing 9f is formed of insulating synthetic resin, and is fitted into a bearing fitting hole 9v4, the axial line of which coincides with that of the magnet supporting hole 9v3. The wall of this hole 9v4 has a key groove 9v5, into which the key portion 9f1 of the bearing 9f fits, preventing therefore the bearing 9f from rotating. The hole 9v4 is not a through hole, and on the bottom wall of this hole 9v4, the inward end portion of the development bias electrode 121 in the form of a donut-shaped disk is provided. As the above described lengthwise end portion of the development roller 9c is fitted into the bearing box 9v, the metallic development bias electrode 9l in the form of a coil spring comes into contact with the electrode 121, being thereby compressed. The electrode 121 has an extension 121a, which extends from the outward edge of the donut-shaped disk portion at an angle, in the axial direction of the hole 9v4, being fitted in the recess 9v6 formed in the wall of the hole 9v4, and which follows the peripheral surface of the bearing 9f. Further, the electrode 121 has, in addition to the extension 121a, or the first extension, a second extension 121b, a third extension 121c, a fourth extension 121d, and an external contact portion 121e. The second extension 121b extends at an angle from the first extension 121a, in the outward direction, in terms of the radius direction of the hole 9v4, and being fitted in the gap 9v7 formed in the edge portion of the hole 9v4, and the third extension 121c extends at an angle from the second extension 121b. The fourth extension 121d extends at an angle in the outward direction, in terms of the radius direction of the hole 9v4, and the external contact portion 121e extends at an angle from the fourth extension 121d. In order to support the electrode 121 structured as described above, the bearing box 9v is provided with a supporting portion 9v8, which protrudes inward. This supporting portion 9v8 contacts the third and fourth extensions 121c and 121d, and external contact portion 121e. The second extension 121b has an anchoring hole 121f, into which a joggle 9v9 projecting inward from the back side of the bearing box 9v is pressed. The contact portion 121e contacts the development bias electrode 125 (FIG. 6) of the apparatus main assembly 14, making it possible to apply development bias to the development roller 9c, as the cartridge B is mounted into the apparatus main assembly 14.

The bearing box 9v has two projections 9v1, which fit into a pair of holes 12m, one for one, (FIG. 15) in one of the lengthwise ends of the developing means holding frame 12, positioning the 9 bearing box 9v relative to the developing means holding frame 12. With the bearing box 9v positioned as described above, a pair of screws (unshown) are put through the screw holes of the bearing box 9v, and screwed into the female-threaded holes 12c of the developing means holding frame 12, solidly securing the bearing box 9v to the developing means holding frame 12. As is evident from the above description, in this embodiment, when attaching the development roller 9c to the developing means holding frame 12, first, the development roller unit G is assembled, and then, the assembled unit G is attached to the developing means holding frame 12.

Next, the rod antenna 9h for detecting the amount of the remaining toner will be described. Referring to FIGS. 11 and 15, one of the lengthwise end portions of the rod antenna 9h is bent like a crank. The end of this crank-like portion of the rod antenna 9h constitutes a contact electrode 9h1 (which hereinafter will be designated with referential code 123 when it is referred to as a contact point), which comes into contact with a toner detection electrode 126, shown in FIG. 6, attached to the apparatus main assembly 14, establishing electrical connection between the rod antenna 9h and toner detection electrode 126. In order to attach the rod antenna 9h to the developing means holding frame 12, first, the end portion of the rod antenna 9h is inserted into the developing means holding frame 12, through a through hole 12b in the aforementioned lateral plate 12B. Then, the entirety of the rod antenna 9h is pushed into the developing means holding frame 12, and its leading end portion is inserted into a hole (unshown) in the lateral plate of the developing means holding frame 12 on the opposite side, to make the developing means holding frame 12 support the rod antenna 9h by the lengthwise ends of the rod antenna 9h. In other words, the rod antenna 9h is positioned and supported by the through hole 12b in the lateral plate 12A and the hole (unshown) in the lateral plate on the opposite side. In order to prevent toner invasion, the through hole 12b is fitted with a sealing member (unshown) (ring formed of synthetic resin, felt, sponge, or the like). As the bearing box 9v is attached to the developing means holding frame 12, the arm portion having the contact point 9h1 is prevented from moving in its lengthwise direction by the bearing box 9v, being therefore prevented from slipping out of the developing means holding frame 12. The lateral plate 12A having the hole through which the end portion of the rod antenna 9h is inserted has an extended portion, which partially covers the toner cap 11f attached to the bottom sub-frame 11b of the toner holding frame 11, as the toner holding frame 11 is joined with the developing means holding frame 12. The lateral plate 12A is provided with a hole (unshown), into which the coupling portion 9s1 (FIG. 12) of the toner sending gear 9s for transmitting driving force to the toner sending member 9b is fitted. This gear 9s is provided with a coupling portion 9s1, which transmits driving force to the Loner sending member 9b by engaging with the coupling portion lie (FIGS. 13 and 16) rotationally supported by the toner holding frame 11. The coupling portion 11e is connected to one of the lengthwise ends of the toner sending member 9b.

Referring to FIG. 15, the toner stirring member 9e is rotationally supported by the developing means holding frame 12, in parallel to the rod antenna 9h. The stirring member 9e is in the form of a crank. One of its journal portions is fitted in the bearing hole (unshown) of the lateral plate B, whereas the other is fitted in the hole of the toner stirring gear 9m having a shaft portion rotationally supported by the lateral plate 12A (FIG. 13), with the arm portion of the stirring member 9e fitted in the slot of the shaft portion to transmit the rotation of the stirring gear 9m to the toner stirring member 9e.

Next, the transmission of driving force to the development unit D will be described.

Referring to FIG. 12, the D-cut shaft portion 9g1 of the magnet 9g is fitted in the supporting hole 40a of the developing means holder 40, being nonrotationally supported. As the developing means holder 40 is attached to the developing means holding frame 12. The development roller gear 9k meshes with the gear 9q of a gear train GT, and the toner stirring gear 9m meshes with a small gear 9s2, enabling the toner sending gear 9s and toner stirring gear 9m to receive driving force from the development roller gear 9k. The gears 9q and 9s, and the gears between them, are all idler gears. The gear 9q which meshes with the gear 9k, and a small gear 9q1 integral with the gear 9q, are fitted around the joggle 40b integral with the developing means holder 40, being thereby rotationally supported by the joggle 40b. A large gear 9r which meshes with the gear 9q1, and a small gear 9r1 integral with the gear 9r, are rotationally supported by a joggle 40c integral with the developing means holder 40. The gear 9r1 is meshed with the gear 9s, which is rotationally supported by the joggle 40d. The gear 9s has the coupling portion 9s1, and is meshed with the gear 9s2, which is rotationally supported by a joggle 40e. With the provision of the above described structural arrangement, the gears making up the gear train can be supported by a single component (developing means holder 40 in this embodiment). Therefore, when assembling a cartridge B, the gear train CT can be attached to the developing means holder 40 through a secondary assembly process. Further, the primary assembly process can be divided into a plurality of secondary assembly processes to simplify the primary assembly process. The development unit D is completed after the rod antenna 9h and toner stirring member 9e are attached to the developing means holding frame 12. This process is carried out at the same time as the development roller unit G and gear box 9v are attached to the driving force transmission unit DG and developing means holding frame 12, respectively.

Referring to FIG. 15, a referential code 12p stands for an opening, the longer edges of which are parallel to the lengthwise direction of the developing means holding frame 12. With the toner holding frame 11 and developing means holding frame 12 Joined with each other, the opening 12p aligns with the opening 11i of the toner holding frame 11, making it possible for the toner in the toner holding frame 11 to be supplied to the development roller 9c. The aforementioned stirring member 9e and rod antenna 9h extend from one lengthwise end of the opening 12p to the other, in parallel to the lengthwise edges of the opening 12p. The material for the developing means holding frame 12 is the same as the material for the toner holding frame 11.

[Electrode Structure]

Next, referring to FIGS. 5, 6, and 8, the electrodes for establishing electrical connection between the process cartridge 13 and image forming apparatus main assembly 14 as the former is mounted into the latter will be described along with the positioning of the electrodes.

Referring to FIG. 5, the cartridge B is provided with a plurality (four) of electrodes: (1) cylindrical guide 13aL (which will be designated with a referential code 119 when described as conductive grounding electrode) as a grounding electrode electrically connected to the photoconductive drum 7 to ground the photoconductive drum 7 through the apparatus main assembly 14; (2) conductive charge bias electrode 120 electrically connected to the charge roller shaft 8a to apply charge bias to the charge roller 8 from the apparatus main assembly 14; (3) conductive development bias electrode 121 electrically connected to the development roller 9c to apply development bias to the development roller 9c from the apparatus main assembly 14; and (4) conductive toner remainder amount detection electrode 122 electrically connected to the rod antenna 9h to detect the amount of the remaining toner. These electrodes 119-122 are positioned so that their contact portions are exposed from the side and bottom walls of the cartridge frame; more specifically, they are exposed from the left side wall, and the left end portion of the bottom wall, respectively, of the cartridge frame, as seen from the upstream side in terms of the cartridge mounting direction, with the provision of intervals large enough to prevent electrical leak among them. The grounding electrode 119 and charge bias electrode 120 are attached to the cleaning unit C, whereas the development bias electrode 121 and toner remainder amount detection electrode 122 are attached to the developing means holding frame 12. Further, the electrode 122 doubles as the cartridge presence detection electrode for detecting the presence (or absence) of the cartridge B in the apparatus main assembly 14. Referring to FIG. 8, the grounding electrode 119 is electrically connected to the photoconductive drum 7. The charge bias electrode 120 and development bias electrode 121 are formed of electrically conductive metallic plate (for example, stainless steel plate or phosphor bronze plate), and are intricately extended from inside the process cartridge B. The charge bias electrode 120 is exposed from the bottom surface of the cleaning unit C, whereas the development bias electrode 121 and toner remainder amount detection electrode 122 are exposed from the bottom surface of the development unit D.

To describe more in detail, referring to FIG. 8, in this embodiment, the photoconductive drum 7 is provided with the drum gear 7b, which is attached to one end of the photoconductive drum 7 in terms of its axial direction. This gear 7b meshes with the development roller gear 9k, rotating the development roller 9c. As it is rotated, it generates thrust (in the direction d indicated in FIG. 8), pressing the photoconductive drum 7 toward the drum gear 7b. As a result, a grounding plate 7f solidly fixed to the flange having a spur gear 7n is pressed by the drum shaft 7a in the direction of the arrow d, generating therefore reactive force, and the lateral surface 7b1 of the gear 7b is placed in contact with the inward end surface 38b of the bearing 38 solidly fixed to the cleaning means holding frame 13. As a result, the position of the photoconductive drum 7, in terms of its axial direction, in the cartridge B is regulated. The grounding electrode 119 is on the inward surface of the one of the lengthwise lateral wall 13k of the cleaning means holding frame 13, being exposed. The drum shaft 7a protrudes inward of the drum cylinder 7d through the center hole of the drum journal. The drum cylinder 7d and drum shaft 7d are electrically connected to each other by the grounding plate 7f, which is in contact with the internal surface 7d1 of the drum cylinder 7d and the end surface 7a1 of the drum shaft 7a.

The charge bias electrode 120 is attached to the cleaning means holding frame 13, near the portion which is supporting the charge roller 8 (FIG. 5).

The development bias electrode 121 and toner remainder amount detection electrode 122 are attached to the bottom wall of the development unit D. The external contact portion of the development bias electrode 121 is disposed opposite to the charge bias electrode 120, with the interposition of the spur gear 7n.

The detection electrode 122 shown in FIG. 5 is disposed on the upstream side of the development bias electrode 121 in terms of the cartridge mounting direction (direction of arrow mark X), being exposed from the developing means holding frame 12.

Next, the connection between the electrodes provided on the process cartridge B side, and the contact electrodes provided on the apparatus main assembly 14 side, will be described. Referring to FIG. 6, the image forming apparatus A is provided with four contact electrodes which come into contact with the aforementioned contact electrodes of the process cartridge B as the process cartridge B is mounted into the image forming apparatus A (grounding electrode 123 which is electrically connected to grounding electrode 119; charge bias electrode 124 which is electrically connected to charge bias electrode 120; development bias electrode 125 which is electrically connected to development bias electrode 121; and toner remainder amount detection electrode 126 which is connected to Loner remainder amount detection electrode 122). As shown in FIG. 6, the grounding electrode 123 is attached to the bottom of the positioning groove 16b. The development bias electrode 125, toner remainder amount detection electrode 126, and charge bias electrode 124 are attached to the bottom wall of the cartridge mounting space S, being positioned below the guiding portion 16a.

[Structures of Coupling and Driving Mechanism]

Next, the coupling means, which is a driving force transmission mechanism for transmitting driving force from the apparatus main assembly 14 to the cartridge B, will be described. FIG. 8 is a vertical sectional view of the coupling assembly. As is evident from FIG. 8, the photoconductive drum 7 is provided with a coupling means, which is attached to one of the lengthwise ends of the photoconductive drum 7. This coupling means is a coupling shaft 37 (cylindrical) which is a part of a drum flange 36 solidly attached to one end of the photoconductive drum 7. The shaft 37 is made up of the base portion, and the end portion 37a (male portion of coupling means) which is projecting from the base portion. The shaft 37 fits in the bearing 38, and functions as the rotational axle of the photoconductive drum 7. The flange 36 is provided with the helical drum gear 7b for transmitting driving force to the development roller 9c. The projection 37A is in the form of a twisted polygonal pillar, more specifically, a pillar, the cross section of which is approximately in the form of an equilateral triangle, and which is twisted in the rotational direction of the photoconductive drum 7. On the other hand, a recess 39a (female portion of coupling means), into which the projection 37b fits, is a hole, the cross section of which is polygonal, and which is twisted in the rotational direction of the photoconductive drum 7. More specifically, the cross section of the recess 39a is approximately in the form of an equilateral triangle. The portion with the recess 39a is a part of the coupling shaft 39b integral with the gear 43 provided on the apparatus main assembly 14 side.

Designated by a referential code 36b is an integral portion of the flange 36, which is fitted into the drum cylinder 7d to attach the flange 36 to the photoconductive drum 7.

Further, the bearing 38, which is solidly fixed to the cleaning means holding frame 13, is provided with a cylindrical projection 38a (cylindrical guide 13aR), which surrounds the projection 37a of the shaft 37 as the shaft 37 is fitted into the bearing 38 (FIG. 9). The bearing 38 doubles as a guiding member for guiding the cartridge B when mounting or dismounting the cartridge 13, into or from, the apparatus main assembly 14.

The gear 43 is a helical gear, and is meshed with a small helical gear solidly attached to the shaft 61a of a motor 61. Thus, as the motor 61 is driven for image formation, the shaft with the recess 39a is moved toward the shaft 37 with the projection 37a, causing the projection 37a to enter the recess 39a.

The cartridge B is mounted in the apparatus main assembly 14, being allowed to move in the lengthwise direction of the cartridge B as well as the cartridge mounting direction indicated by an arrow mark X (FIG. 6). As the cartridge B is inserted into the apparatus main assembly 14, the cylindrical guide 13aL (FIGS. 4 and 6) drops into the groove 16b (FIG. 6), being thereby positioned. As for the other lengthwise end of the photoconductive drum 7 (side from which photoconductive drum 7 is driven, which hereinafter may be referred to as driven side), the cylindrical guide 13aR is supported by the positioning groove 16d.

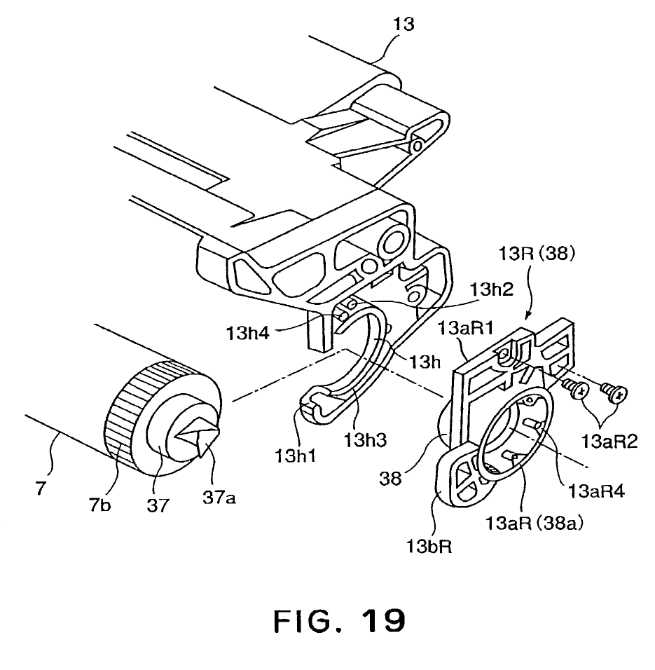

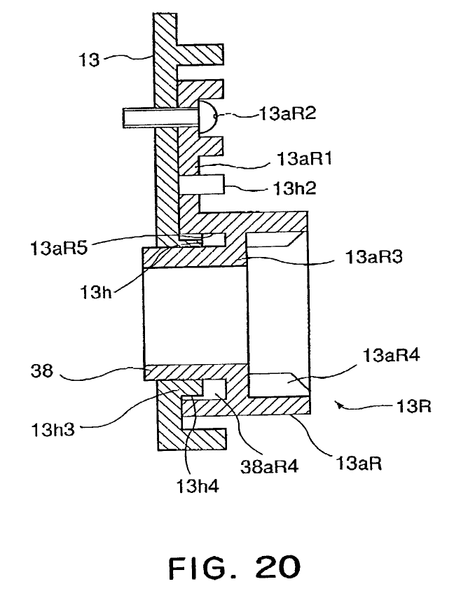

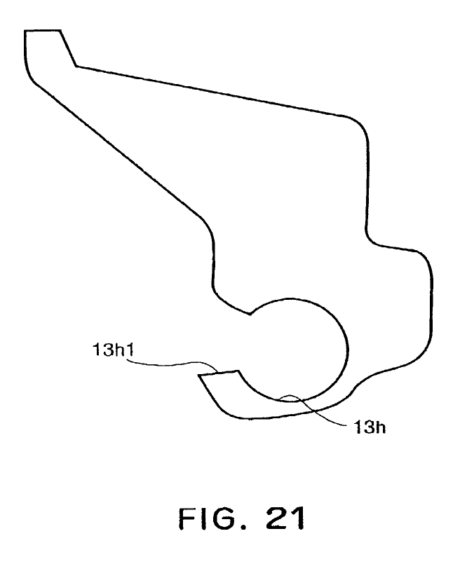

FIG. 19 is a perspective drawing for showing the relationship between the guiding member 13R and cleaning means holding frame 13, in terms of how the former is attached to the latter, and FIG. 20 is a vertical sectional view of the guiding member 13R and cleaning means holding frame 13 after the attachment of the former to the latter. FIG. 21 is a drawing for showing a part of the surface of the cleaning means holding frame 13 on the right-hand side. The bearing 38 is an integral part of the rear side of the guiding member 13R, and its axial line coincides with that of the cylindrical guide 13aR (FIGS. 19 and 20). The bearing 38 has a donut-shaped portion 13aR3. There is a gap between the bearing 38 and guide 13aR, forming a cylindrical groove 38aR4. One of the lateral walls of the cleaning means holding frame 13 is provided with a hole 13h into which the bearing 38 is fitted (FIGS. 19 and 21). The width of the missing portion 13h1 of the wall of the hole 13h, in terms of the direction perpendicular to the radius direction of the hole 13h, is smaller than the diameter of the hole 13h, and is greater than the diameter of the shaft 37. The aforementioned lateral wall of the cleaning means holding frame 13 is provided with a positioning pin 13h2, which fits into the flange 13aR1 of the guiding member 13R. With the provision of the above described structural arrangement, the unitized photoconductive drum 7 can be mounted into the cleaning means holding frame 13 from the direction perpendicular to the axial direction (lengthwise direction) of the photoconductive drum 7. Further, the guiding member 13R is accurately positioned relative to the cleaning means holding frame 13 when attaching the guiding member 13R to the cleaning means holding frame 13. In order to attach the photoconductive drum 7 to the cleaning means holding frame 13, the photoconductive drum 7 is to be moved in the direction perpendicular to the lengthwise direction of the photoconductive drum 7 (FIG. 19). During this movement of the photoconductive drum 7, the shaft 37 is to be inserted into the hole 13h through the missing portion 13h1, or the gap, of the surrounding wall of the hole 13h. With the photoconductive drum 7 held in this state, the drum shaft 7a integral with the guide 13aL is to be put through the lateral end wall 13k of the cleaning means holding frame 13, so that the drum gear 7a is meshed with the spur gear 7n. Next, a pair of small screws 13d are put through the flange 29, and arc screwed into the cleaning means holding frame 13, solidly attaching the guide 13aL to the cleaning means holding frame 13, and supporting the photoconductive drum 7 by one of the lengthwise ends. Next, the bearing 38 integral with the guiding member 13R is fitted into the bearing hole 13h so that the shaft 37 is fitted into the bearing 38. Then, the positioning pin 13h2 is fitted into the hole of the flange 13aR1 Thereafter, a pair of screws 13aR2 are put through the flange 13aR1 and are screwed into the cleaning means holding frame 13, solidly fixing the guiding member 13R to the cleaning means holding frame 13. The guiding portion 13aR4 is a portion for guiding the shaft with the recess 39a.

[Remanufacture of Process Cartridge]

Next, the process cartridge remanufacturing method in this embodiment of the present invention will be described.

In order to remanufacture the process cartridge in this embodiment, first, the process cartridge is separated into the development unit and cleaning unit after the depletion of the toner from the process cartridge. In terms of function, a remanufactured process cartridge is the same as a brand-new one. In terms of structure, however, a part of its development unit is different from that of a brand-new one. To describe concretely, the development unit of a remanufactured process cartridge is different from that of a brand-new one in that the former does not have the cover film 51 (FIG. 17) which seals the opening 111 (FIG. 16) of the toner holding frame 11 (neither is the torn cover film 51 restored, nor is the opening sealed with brand-new cover film 51), and that the interfaces between the development roller unit G (FIG. 11) and the developing means holding frame 12, and between the development blade 9d and developing means holding frame 12, are better sealed to compensate for the lack of the cover film 51. If the film 51 is restored, a remanufactured process cartridge is virtually the same as a brand-new process cartridge. In the process cartridge remanufacturing method in this embodiment, which will be described hereinafter, the cover film 51 is not restored. When remanufacturing a process cartridge, the development unit D can be scaled approximately as well as the development unit D in a brand-new process cartridge is sealed, without attaching a new film 51 or restoring the old film 51.

First, a method for sealing the development unit D well enough to prevent toner from leaking from the development unit D, without the film 51, will be described.

According to this embodiment which will be described hereinafter, it is possible to prevent toner from leaking during the ordinary handling of the process cartridge, for example, while a user is mounting or dismounting the cartridge B, into or from, the image forming apparatus A, or is carrying the cartridge B by hand. Further, it is possible to prevent toner from leaking even under severe conditions, for example, while the cartridge B is transported by truck, ship, aircraft, or the like; after its remanufacture in a factory. To described in more detail, while a cartridge is shipped out of a factory and is transported to be handed to a user, vibrations and impacts which are much greater than those to which the cartridge will be normally subjected when it is normally used by a user act on the cartridge B. According to the remanufacturing method in this embodiment, toner can be prevented from leaking during the transportation of the cartridge B, even if the film 51 is not used. In other words, the toner leakage from the cartridge B can be prevented well enough for the cartridge B to be sold as a viable product.

To describe concretely, with the presence of the film 51, the opening 11i is sealed, and therefore, the back side of the development blade 9d (FIGS. 2 and 18) (opposite side of development roller 9c), and the adjacencies of the toner stirring member 9e and rod antenna 9h, are not filled with toner. Thus, the interfaces between the development roller unit C and developing means holding frame 12 and between the development blade 9d and developing means holding frame 12 have only to be sealed enough to prevent toner from leaking during the aforementioned period, that is, while the cartridge B is handled by a user. However, if the film 51 is not attached when remanufacturing the cartridge B, the back side of the development blade 9d (opposite side of development roller 9c), and the adjacencies of the toner stirring member 9e and rod antenna 9h, are going to be filled with toner. Thus, the interfaces between the development roller unit G and developing means holding frame 12 and between the development blade 9d and developing means holding frame 12 must be sealed enough to prevent toner from leaking during the transportation of the cartridge B.

Therefore, the cartridge B remanufacturing method in this embodiment seals the interfaces between the development roller unit G and developing means holding frame 12 and between the development blade 9d and developing means holding frame 12 enough to prevent toner from leaking the interfaces, instead of attaching a new film 51.

[Process for Separating Development Unit from Cleaning Unit]

Next, the process for separating the development unit D from the cleaning unit C will be described. As described before, the developing means holding frame 12 and drum holding frame 13 were joined to each other by putting the connecting members 22 through the holes 20 of the left and right arm portions 19 of the developing means holding frame 12, and the left and right holes 13c of the drum holding frame 13. Therefore, when disassembling the cartridge B, the connecting members 22 are pulled out or the above described holes, separating the developing means holding frame 12 from the drum holding frame 13. As is evident from the above description, according to this embodiment the disassembly of the cartridge B is very simple. Incidentally, in order to pull out the connecting members 22, a dedicated pulling tool designed in accordance with cartridge shape, or an ordinary tool, such as a nipper or a plier, may be used. After the separation, the development unit D and cleaning unit C appear as shown in FIGS. 9 and 10.

[Process for Removing Development Roller]

The unit G is supported by attaching the bearing box 9v and driving force transmission unit DG to the lateral plates 12B and 12C of the developing means holding frame 12, as described in the above described [Development Means Holding Frame] section (FIGS. 11, 12 and 14). Therefore, in order to remove the development roller, the screws (unshown) holding the box 9v and unit DG to the lateral plates 12B and 12A of the developing means holding frame 12 are removed with the use of a screwdriver. Then, the box 9v and unit DG are removed from the frame 12 Thereafter, the development roller unit G is lifted out of the frame 12; the development roller 9c is removed from the frame 12.

[Process for Removing Development Blade]

The development blade 9d also were attached to the frame 12 as described in the above described [Development Means Holding Frame] section. More specifically, in order to solidly attach the metallic plate 9d1 to the blade anchoring surface 12i, as a blade attachment portion, of the frame 12, the screws 9d6 were put through the screw holes 9d4 of the metallic plate 9d1, and were screwed into the female-threaded holes 12i2 in the blade anchoring surface 12i. Thus, in order to remove the development blade 9d, the screws 9d6 are removed from the frame 12 with the use of a tool such as a screwdriver. Then, the development blade 9d is lifted out the frame 12; the development blade 9d is removed from the frame 12.

[Process for Removing Elastic Sealing Member]

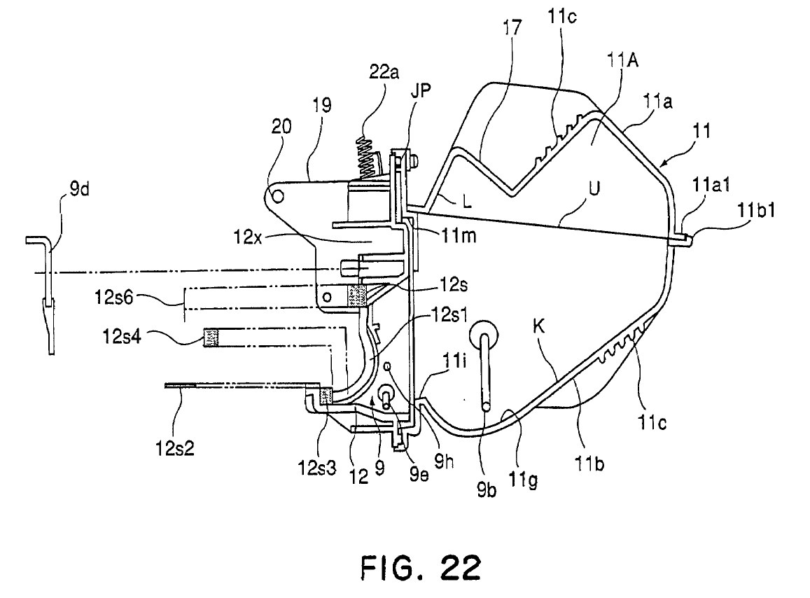

Referring to FIGS. 2 and 11, the thin elastic sealing member 12s2 was pasted to the mandible-like portion 12h (elastic sealing member pasting surface 12h1 of stepped portion 12h2 in FIG. 22), being positioned so that it contacts the generatrix of the development roller 9c to seal the gap which extends in the lengthwise direction of the cartridge B between the frame 12 and the peripheral surface of the development roller 9c; one of the edges 9 in terms of the widthwise direction, that is, one of the long edges of this elastic sealing member 12s2 was pasted to the mandible-like portion 12h with the use of pasting means such as double-sided adhesive tape. The other long edge was elastically placed in contact with the peripheral surface of the development roller 9c; in other words, the gap between the frame 12 and the peripheral surface of the development roller 9c was sealed by elastically bending the sealing member 12s2 in the direction perpendicular to the lengthwise direction to prevent toner from leaking out through the gap between the development roller 9c and frame 12.

In this cartridge B remanufacturing method, the original elastic sealing member 12s2 is replaced with a sealing member (12s2) which is wider and thicker than the original elastic sealing member 12s2; the replacement sealing member (12s2) is pasted to the elastic sealing member anchoring surface 12h1 with the use of double-sided adhesive tape, in such a manner that the center portion of the double-sided adhesive tape protrudes from the elastic sealing member anchoring surface 12h1 toward the development roller 9c, as will be described later. In order to do so, first, the original scaling member 12s2 on the mandible-like portion 12h is peeled off. As for the peeling method, all that is necessary to pull the sealing member 12s2 in contact with the development roller 9c by hand, or a pair of tweezers or the like. If the adhesive of the double-sided adhesive tape remains on the mandible-like portion 12h after the peeling of the sealing member 12s2, it should be wiped away with the use of alcohol or the like.

[Process for Attaching Thin Plate]

As described before, in this process cartridge remanufacturing method, the film 51 is not restored. Thus, a certain measure for preventing toner from leaking from between the unit G and frame 12 is taken. As one of the examples of such a measure, a thin plate is pasted to the elongated seal which seals the gap between the frame 12 and development blade 9d.

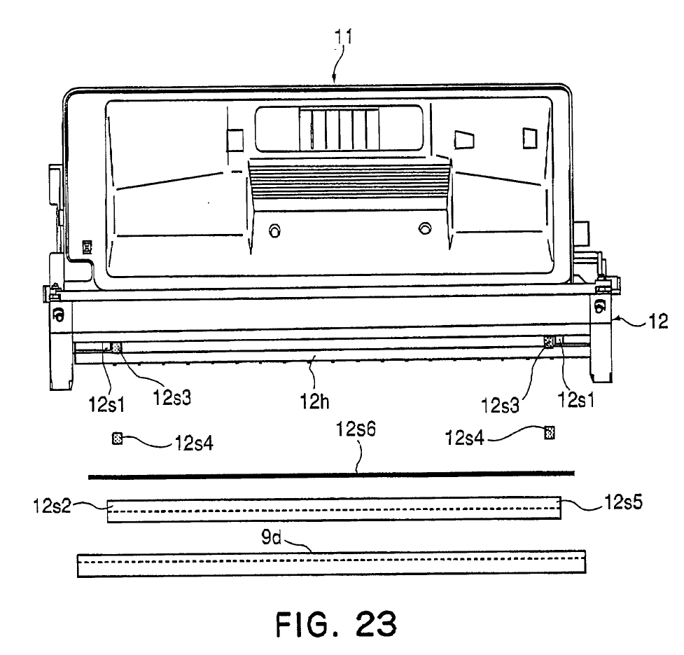

FIG. 22 is a sectional drawing for describing the process for attaching a toner leak prevention member with the use of the process cartridge remanufacturing method in this embodiment, in order to prevent the toner leak, and FIG. 23 is a top plan view of the developing means holding frame 12. In FIGS. 22 and 23, a referential code 12s6 stands for a piece of thin plate for improving the sealing performance of the elastic sealing member 12s, or the elongated seal for sealing between the frame 12 and development blade 9d. The thin plate 12s6 is formed of polyethylene-terephthalate (PET) or the like. It is pasted to the top surface of the elastic sealing member 12s using pasting means such as double-sided adhesive tape, adhesive, or the like. In terms of the lengthwise direction of the cartridge B, the dimension of the thin plate 12s6 is equal to that of the elastic sealing member 12s, whereas in terms of the widthwise direction of the cartridge B, the dimension of the thin plate 12s6 is greater than that of the elastic sealing member 12s. Thus, the thin plate 12s6 is pasted so that it protrudes from the elastic sealing member 12s on the development roller 9c side, by the distance equivalent to the amount by which the thin plate 12s6 is wider than the elastic sealing member 12s. The addition of the thin plate 12s6 increases the amount by which the elastic sealing member 12s formed of Moltprene is compressed. Further, if toner particles pass by the sealing member 12s, they are dammed by the thin plate 12s6, better sealing the aforementioned gap.

[Process for Attaching Second Auxiliary Development End Seal]

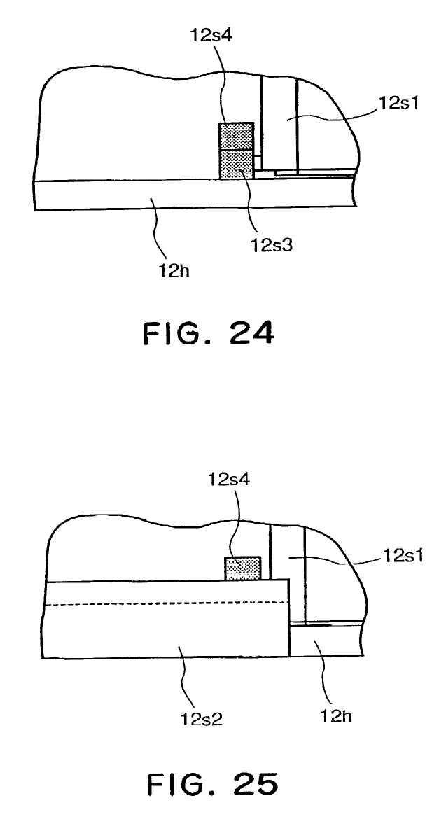

Referring to FIGS. 22-24, designated by a referential code 12s3 is a first auxiliary seal for sealing the gap next to the one of the lengthwise ends of the development roller 9c. A pair of auxiliary seal 12s3 are pasted in advance to the developing means holding frame 12 to prevent toner from leaking from between the magnetic sealing member 12s1 and elastic sealing member 12s2. The auxiliary seal 12s3 is in the form of a parallelepiped or a cube, and is formed of Moltprene. It is pasted to the developing means holding frame 12, with the use of double-sided adhesive tape, on the location which is on the inward side of the magnetic sealing member 12s1, and which is covered with the elastic sealing member 12s2, and also on the location which is on the outward side of the magnetic sealing member 12s1, that is, the side opposite to the development roller 9c with respect to the magnetic sealing member 12s1 (two auxiliary seals 12s3 are pasted to the left and right ends, one for one). In this remanufacturing method, in order to enhance the sealing performance of the auxiliary seal 12s3, a pair of second auxiliary Seals 12s4 for sealing the gaps in the adjacencies of the lengthwise end portions of the development roller 9c are pasted. These seals 12s4 were not pasted to the developing means holding frame 12 in a brand-new cartridge. Referring to FIG. 23, the auxiliary seal 12a4 is similar in shape to the auxiliary seal 12s3. Referring to FIG. 24, the auxiliary seal 12s4 is pasted to the developing means holding frame 12 with the use of pasting means such as double-sided adhesive tape or adhesive, being placed in contact with the auxiliary seal 12s3, on the development roller 9c side, in such a manner that it follows the inward side of the magnetic sealing member 12s1 FIG. 24 is an enlarged top plan view of a part of the developing means holding frame 12, to which the auxiliary seal 12s4 has been attached.

[Process for Pasting Elastic Sealing Member]

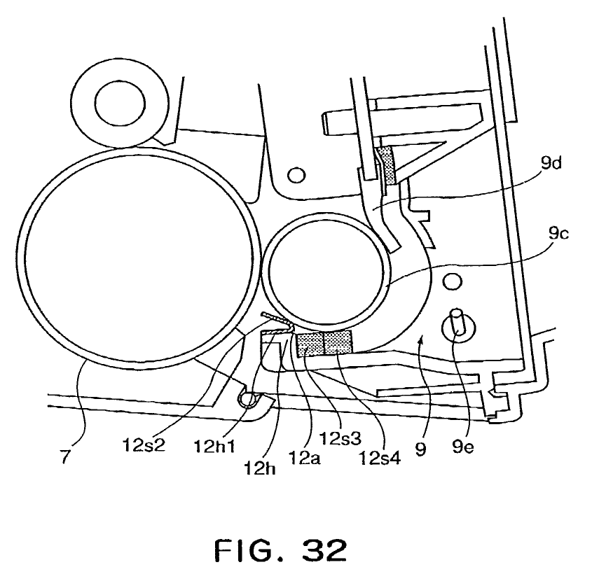

Next, the elastic sealing member 12s2, which was peeled in the above described [Process for Removing Thin Elastic Sealing Member] section is reattached to the mandible-like portion 12h. The elastic sealing member 12s2 was peeled for improving the efficiency with which [Process for Attaching Second Auxiliary Seal for Adjacencies of Development Roller] is carried out, and for preventing the free long edge portion of the elastic sealing member 12s2 from being peeled away from the peripheral surface of the development roller 9n. Here, the phenomenon that the free long edge portion of the elastic sealing member 12s2 is peeled away from the peripheral surface of the development roller 9c will be described. The elastic sealing member 12s2 was pasted to the mandible-like portion 12h (bottom sub-frame of developing means holding frame) by one of its long edges, with the use of pasting means such as double-sided adhesive tape as described above, and the other long edge was placed elastically in contact with the peripheral surface of the development roller 9c (by bending elastic sealing member in direction perpendicular to lengthwise direction of development roller 9c) to seal the gap between the peripheral surface of the development roller 9c and developing means holding frame 12. To describe in more detail, referring to FIG. 2, the development roller 9c rotates counterclockwise, whereas the elastic sealing member 12s2 is attached to the elastic sealing member pasting surface 12h1 by the upstream side in terms of the moving direction of the peripheral surface of the development roller 9c. In other words, the sealing member 12s2 is pasted so that the direction ill which the sealing member 12s2 extends in terms of its widthwise direction agrees with the rotational direction of the development roller 9c. However, the sealing member 12s2 is pushed up by the toner particles under the sealing member 12s2 (this pressure is sometimes referred to as toner pressure). If this toner pressure becomes excessive due to the vibrations and/or impacts which occur during the transportation of the cartridge B, it is possible that the free long edge or the sealing member 12s2 will be partially, or entirely, peeled away from the peripheral surface of the development roller 9c and bent toward the photoconductive drum 7 as shown in FIG. 32. This is the aforementioned phenomenon called “peeling”. FIG. 32 is an enlarged sectional view of the development roller 9c and its adjacencies. As the elastic sealing member 12s2 is “peeled”, it fails to function as a seal, allowing toner to blow out through the gap between the development roller 9c and mandible-like portion 12h. According to the process cartridge remanufacturing method in this embodiment, however, the original elastic sealing member 12s2 is replaced with an elastic sealing member 12s2, the dimension of which in terms of the widthwise direction and the thickness of which are greater than those of the original elastic sealing member 12s2, in other words, an elastic sealing member 12s2 stronger than the original elastic sealing member 12s2, preventing thereby the occurrence of “peeling”. Incidentally, the original sealing member 12s2 is approximately 8 mm in the dimension in terms of the widthwise direction, and approximately 39 μm in thickness, whereas the sealing member 12s2 pasted in this process cartridge remanufacturing process is approximately 13 mm in the dimension in terms of the widthwise direction, and approximately 50 μm in thickness.

FIGS. 22 and 23 are drawings for showing the process for pasting the sealing member 12s2, and FIG. 25 is an enlarged top view of one of the lengthwise end portions of the developing means holding frame 12.

Referring to FIG. 25, the elastic sealing member 12s2 is pasted to the elastic sealing member pasting surface 12h1 of the mandible-like portion 12h (bottom sub-frame of developing means holding frame), with the use of double-sided adhesive tape, so that the entire surface of the auxiliary seal 12s3 and a part of the magnetic sealing member 12s1 is covered with the elastic sealing member 12s2.

Further, the elastic sealing member 12s2 is pasted so that it is bent in the direction perpendicular to the lengthwise direction, making it more difficult for the sealing member 12s2 to be “peeled”.

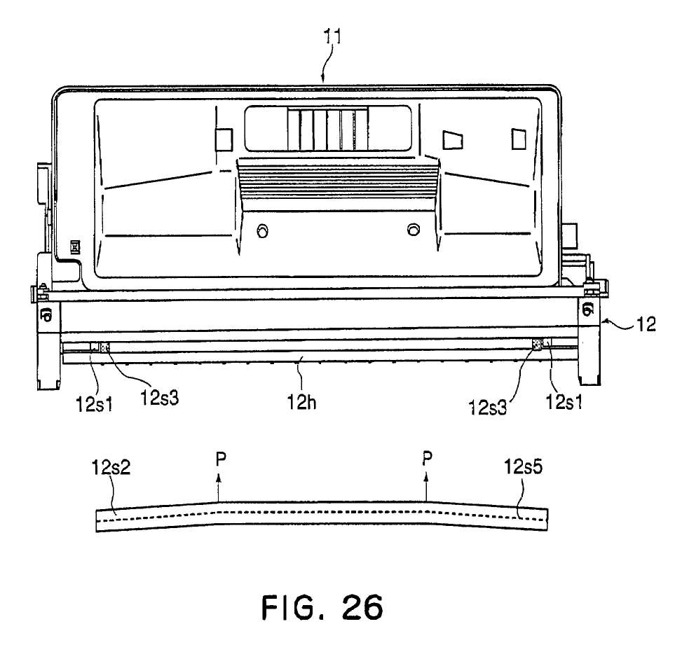

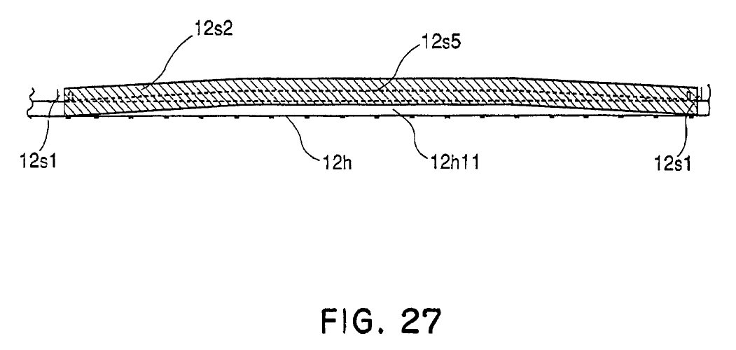

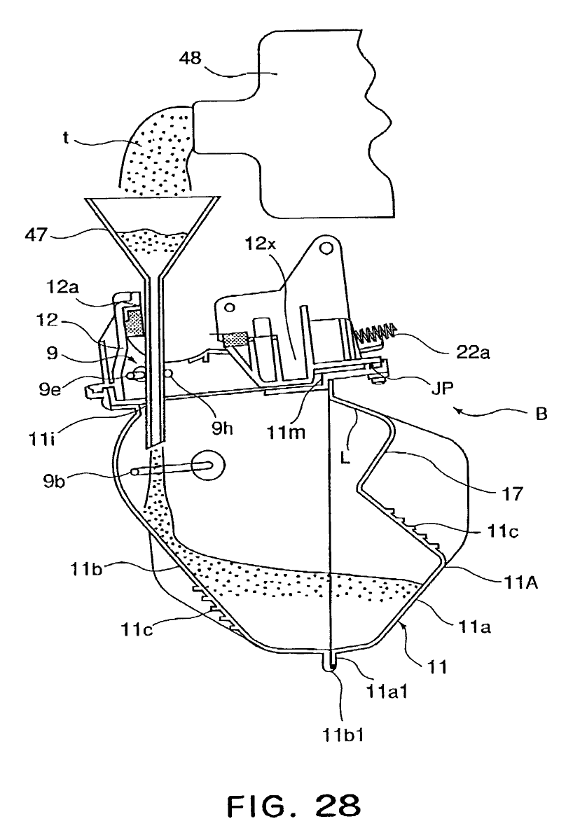

Referring to FIGS. 26 and 27, the above description will be elaborated.

FIG. 26 is a drawing for showing the process for pasting the sealing member 12s2, and FIG. 27 is the mandible-like portion 12h and sealing member 12s2 enlarged to make it easier to understand the manner in which the latter is pasted to the former.

In the sealing member pasting process, as the sealing member 12s2 is pulled by the two points indicated by a referential code P in FIG. 26, it bends toward the development roller 9c. If the sealing member 12s2 in this state is pasted to the pasting surface 12h1, it remains bent after the pasting. Referring to FIG. 27, the hatched member is the elastic sealing member 12s2, and the double-sided adhesive tape 12s5 pasted on the back side of the elastic sealing member 12s2 is contoured with broken lines; the double-side adhesive 12s5 has been bent because the sealing member 12s2 has been bent. If the sealing member 12s2 bent in this manner is pasted to the pasting surface 12h1, the double-sided adhesive tape 12s5, in particular, its center portion, protrudes from the pasting surface 12h1 toward the development roller 9c. In this embodiment, the sealing member 12s2 is pasted to the pasting surface 12h1 while keeping the scaling member 12s2 bent so that the center portion of the double sided adhesive tape 12s5 will protrude from the pasting surface 12h1 approximately 1.7 mm after the pasting. As a result, the tension generated as the center portion is bent acts on the elastic scaling member 12s2. In addition, the double-side adhesive 12s5 is stuck on the back side of the sealing member 12s2. Therefore, the sealing member 12s2 resists the force which works in the direction to peel the free long edge of the sealing member 12s2 in the direction shown in FIG. 32. In other words, the force which acts in the direction to pull the free long edge of the sealing member 12s2 in the direction shown in FIG. 32 ends up pulling the portion of the sealing member 12s2 from which the double-sided adhesive tape is protruding. Therefore, the sealing member 12s2 is less likely to be bent as shown in FIG. 32 by the toner pressure.

Since the sealing member 12s2 is pasted as described above, it is possible to prevent the toner pressure from causing the phenomenon that the free edge portion of the sealing member 12s2 is peeled away from the peripheral surface of the development roller 9c by the toner pressure

Although it was stated in the preceding paragraph that the sealing member 12s2 was pulled by the two points indicated by the referential code P in FIG. 26, the sealing member 12s2 may be pasted in such a manner that the portion between the two points P is first pasted to the pasting surface 12h1, and then, the lengthwise end portions are pasted while being kept slightly bent in the direction opposite to the development roller 9c.

[Process for Refilling Toner Container with Toner]

Next, the toner container 11A is refilled with toner. Referring to FIG. 28, this process is to be carried out with the development unit D held so that the opening 11i faces upward and the toner container 11A is positioned at the bottom. First, the end of a funnel 47 is inserted into the opening 11i, and the toner t is allowed to fall into the toner container 11A from the funnel 47. With the use of an automatic filling apparatus equipped with a funnel which contains an auger, and is enabled to release toner by a predetermined amount, it is possible to more efficiently refill the toner container 11A with toner.

[Process for Reattaching Development Blade]

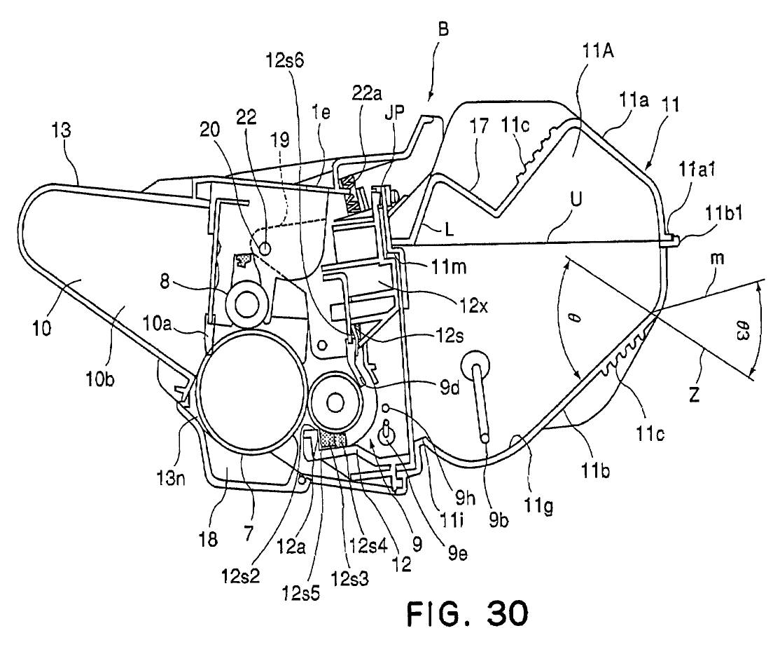

Next, the development blade 9d is reattached to the developing means holding frame 12. When reattaching the development blade 9d, first, the toner particles adhering to the blade 9d are removed by blowing air or the like upon the blade 9d, and then, the blade 9d is attached in reverse in terms of the front and back to the blade 9d, for the following reason. That is, referring to FIGS. 2 and 22, in a brand-new cartridge, the bent portion 9d1a of the metallic plate 9d1 of the development blade 9d is facing the toner container 11A. In comparison, when remanufacturing a cartridge, the development blade 9d is attached to the developing means holding frame 12 so that the bend portion 9d1 faces the photoconductive drum 7 as shown in FIGS. 22 and 30.

Next, the reason for reattaching the development blade 9d in reverse will be described.

As described before, the silicone rubber portion 9d2 of the development blade 9d regulates the amount by which toner is borne on the peripheral surface of the development roller 9c, so that a predetermined amount of toner is borne on the peripheral surface of the development roller 9c as the development roller 9c is rotated for image formation. It also gives-toner a predetermined amount of triboelectric charge. Thus, while the development roller 9c rotates, the corner portion of the rubber portion 9d2 continuously rubs against toner, being thereby gradually shaved by the toner particles. Eventually, a substantial number of scars appear across the corner portion of the rubber portion 9d2, extending in the rotational direction of the development roller 9c. These scars keep on growing, resulting in the formation of defective images, for example, images having scratchy lines, images uneven in density, or the like. In the case of a brand-new process cartridge, the development blade 9d is provided with a sufficient amount of margin for ensuring that the aforementioned scars do not develop enough to produce defective images before the service life of the cartridge expires, more specifically, before the cartridge becomes depleted of toner. However, if a process cartridge, the service life of which had expired, is remanufactured for reuse, it is possible that the scars of the silicon rubber portion 9d2 will grow beyond the tolerable range, effecting image defects, during the second life of the process cartridge. In order to prevent this problem, it is possible to examine all the scars of the silicon rubber portion 9d2 to find out if it is usable for remanufacture, before starting to remanufacture the cartridge from which the silicon rubber portion 9d2 came. However, it is not easy to count a large number of scars, or to measure the thickness of each scar. For example, it requires expensive measuring devices such as a microscope or a surface roughness gauge, as well as a substantial amount of time. Thus, in this embodiment, based on the fact that the back surface of the silicon rubber portion 9d2 is not frictionally scarred by toner, the blade 9d is attached in reverse, in terms of the front and back sides, to the frame 12 when remanufacturing the cartridge. Reusing the original blade 9d in the above described manner makes it possible for the original blade 9d, which was scarred, to perform just as well as a brand-new blade 9d, which is free of scars.

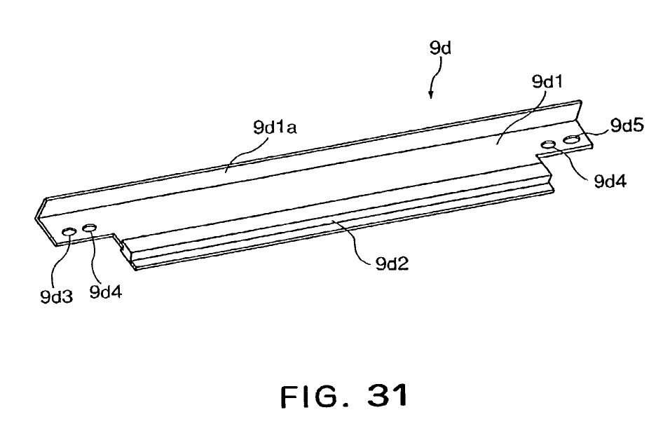

The state of the development blade 9d in a process cartridge prior to remanufacturing, that is, the state of the development blade 9d in a brand-new process cartridge, is as follows. Referring to FIGS. 2 and 11, in order to prevent the bent portion 9d1a of the metallic plate 9d1 from interfering with the developing means holding frame 12 as the development blade 9d is mounted so that the bent portion 9d1a faces the toner container 11A, the frame 12 is provided with a recess 12x. Further, referring to FIG. 31, the development blade 9d is made virtually symmetrical, except for the presence of the positioning holes 9d3 and the elongated hole 9d, with reference to the center line in terms of the lengthwise direction. Thus, in this embodiment, the holes 9d3, elongated hole 9d3, and screw holes 9d4 of the metallic plate 9d1 are positioned so that even if the blade 9d is placed in reverse in terms of the front and hank sides, they align with the joggles 12i1 and screw holes 12i2 of the lengthwise ends of the flat surface 12i (FIG. 11) as a blade holding portion, respectively. Thus, when attaching the blade 9d in reverse, all that happens is that the hole 9d3 and elongated hole 9d5 of the left end portion of the blade 9d, which originally corresponded to the hole and joggle of the left end portion of the frame 12, are made to correspond to the hole and joggle of the right end portion of the frame 12, and that the hole 9d3 and elongated hole 9d5 of the right end portion of the blade 9d, which originally corresponded to the hole and joggle of the right end portion of the frame 12, are made to correspond to the hole and joggle of the left end portion of the frame 12. Therefore, the blade 9d can be attached in reverse to the surface 12i with the same accuracy as that with which it was originally attached to the surface 12i. When reattaching the development blade 9d in reverse in terms of the front and back sides, it is attached in the same manner as it was originally attached; the screws 9d6 are put through the screws holes 9d4, and are screwed into the aforementioned female-threaded holes 12i2 to solidify attach the metallic plate 9d1 to the flat-surface 12i. In this embodiment, originally, the development roller 9c is attached to the frame 12 so that the bent portion 9d1a faces the toner container 11A, whereas when remanufacturing a process cartridge, it is attached so that the bent portion 9d1a faces the photoconductive drum 7 on the opposite side. However, the manner in which the development roller 9c is attached doe not need to be limited to the above described one. For example, there will be no problem even if the blade 9d is originally attached to the frame 12 so that it faces the photoconductive drum 7, whereas when remanufacturing a process cartridge, it is attached so that it faces the toner container 1A. Obviously, there will be also no problem in terms of process cartridge remanufacture, even if the right hole 9d3 and right elongated hole 9d5, which are the holes for positioning the development blade 9d, are switched in location with the left hole 9d3 and left elongated hole 9d5, which also are the holes for positioning the development blade 9d. Further, although the metallic plate 9d1 of the development blade 9d is provided with the bent portion 9d1a, the provision of the bent portion 9d1a is not mandatory: even if the metallic plate 9d1 is flat, there is no problem in terms of the process cartridge remanufacturing method. If the metallic plate 9d1 is flat, it is unnecessary to provide the developing means holding frame 12 with the recess 12x. Further, in this embodiment, the portion of the development blade 9d, which is placed in contact with the development roller 9c, was formed of silicone rubber. However, the material therefor does not need to be limited to silicone rubber. For example, it may be synthetic rubber (urethane rubber or the like), natural rubber, or the like; in other words, it may be any elastic substance, the elasticity of which can be used to maintain a predetermined amount of contact pressure between the development blade 9d and development roller 9c.

[Process for Reattaching Development Roller]

Next, the development roller unit G is attached.

The development roller 9c, spacer rings 9i, and development roller gear 9k, are removed from the development roller unit G, which had been removed in the preceding section [Process for Removing Development Roller Unit], and the Loner particles adhering thereon are removed by blowing air or the like upon them. Then, they are examined to determine whether or not they are reusable. Those which do not meet the performance requirements will be replaced with brand-new ones. If a certain component is known, through the studies made in the development process or Remanufacture process, to be high in statistical probability with which it needs to be replaced during process cartridge remanufacture, it should be replaced with a brand-new one without being examined, in order to improve remanufacture efficiency. The flange 9p, magnet 9g in the development roller 9c, journal 9w, and development bias electrode 9l in the form of a coil spring, are not separated from their counterparts. After the completion of a series of the above described cleaning and examining operations, the components are reattached to the unit G. Then, the reassembled unit G is reattached to the developing means holding frame 12 by reattaching the box 9v and unit DC to the developing means holding frame 12 by screwing the screws (unshown) into the lateral plates 12B and 12A, as it was when it was new.

[Process for Remanufacturing Cleaning Unit]

Next, the cleaning unit is remanufactured.

Referring to FIGS. 8 and 9, the photoconductive drum 7 is provided with the flange 36 attached to one of the lengthwise ends of the photosensitive drum 7 by crimping, gluing, or the like. It also is provided with the spur gear 7n, which is fixed to the other lengthwise end. The flange gear 36 is rotationally attached to the cleaning means holding frame 13 with the interposition of the baring 38, whereas the gear 7n is rotationally attached to the cleaning means holding frame 13 by the flange 29 integrally comprising the drum shaft 7a, large diameter shaft portion 7a2, and guide 13aL. Referring to FIG. 19, the bearing 38 is attached to the cleaning means holding frame 13 with the use of the pair of screws 13aR2. Referring to FIG. 18, the flange 29 is attached to the cleaning means holding frame 13, with the use of the pair of screws 13d. Therefore, the photoconductive drum 7 can be removed from the cleaning means holding frame 13 by removing the bearing 38 and flange 29.

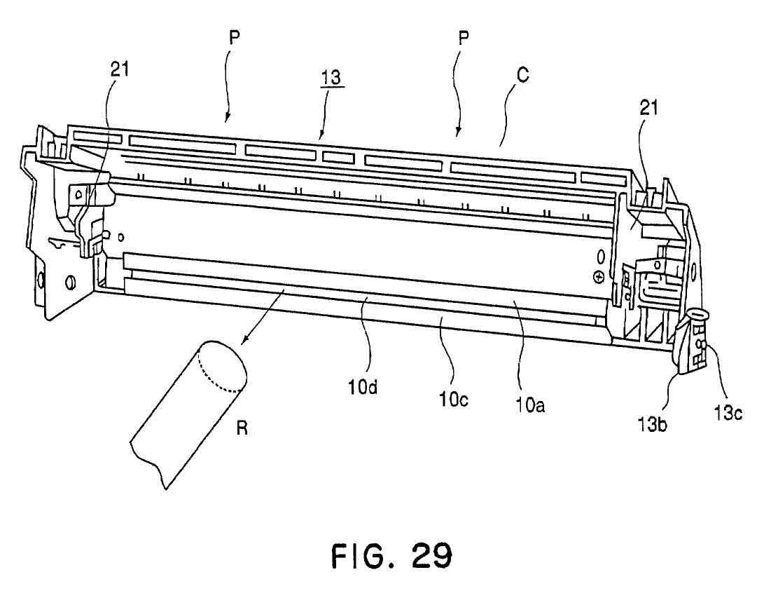

Next, referring to FIG. 29, the cleaning unit C from which the photoconductive drum 7 has been removed is placed on an appropriate table, as is fixed thereto. Then, the suctioning opening of a vacuuming apparatus (unshown) is pressed on the cleaning unit C, cross the gap 10d between the blade 10a and toner catching sheet 10c, by holding the suction nozzle of the vacuuming apparatus by hand. Then, in order to suction the removed toner in the unit C, the suction nozzle R is horizontally moved along the gap 10d, while keeping the opening of the nozzle R aligned with the gap 10d and tapping the top surface of the unit C on the location indicated by an arrow mark P. After the completion of the extraction of the removed toner, the blade 10a and toner catching sheet 10c are removed from the unit C, and then, the interiors of the cleaning means holding frame 13 and removed toner bin 10b are cleaning by air or the like. Upon the removed photoconductive drum 7 and blade 10a, air or the like is blown to remove the toner adhering thereto. Thereafter, each component is examined to determine whether or not it is reusable. After the examination, those which do not meet their performance standards are replaced with brand-new ones. However, if a certain component is known, through the statistical studies made in the development process or remanufacture process, to be high in probability with which it needs to be replaced during process cartridge remanufacture, it should be replaced with a brand-new one without being examined, in order to improve remanufacture efficiency. Thus, a brand-new blade 10a or a reusable blade 10a, and a brand-new toner catching sheet 10c, are attached to the cleaning means holding frame 13. Then, a brand-new photoconductive drum 7 or a reusable photoconductive drum 7 is rotationally attached to the frame 13 by attaching the bearing 38 and flange 29 to the frame 13 with the use of the pair of screws 13aR2 (FIG. 19) and the pair of screws 13d (FIG. 18).

[Unit Rejoining Process for Rejoining Development Unit and Cleaning Unit]

The development unit D, which has been remanufactured through [Process for Removing Development Roller], [Process for Removing Development Blade], [Process for Removing Elastic Sealing Member], [Process for Attaching Thin Plate], [Process for Attaching Second Auxiliary Seal for Adjacencies of Development Roller], [Process for Pasting Elastic Sealing Member], [Process for Refilling Toner Container with Toner] and [Process for Reattaching Development Roller], and the cleaning unit C, which has been remanufactured through [Process for Remanufacturing Cleaning Unit], and united following in reverse [Process for Separating Development Unit and Cleaning Unit]. In other words, as described in {Structure of Housing of Process Cartridge B}, the end portion of each of the pair of arms 19 of the end portions of the frame 12 (FIG. 10) in terms of the lengthwise direction (axial direction of development roller 9c) is inserted into the recess 21 of the corresponding end portion of the frame 13 (FIG. 9), which is provided for accommodating the arm 19. Thereafter, the pair of connecting members 22 are pressed into the corresponding holes 13e of the frame 13, are put through the through holes in the end portions of the arm portion 19s, and are pressed into the inward holes 13e of the frame 13, being secured to the frame 13. As a result, the development unit D and cleaning unit C are connected to each other, being allowed to rotate about the connecting members 22.

Given above are the essential process cartridge remanufacturing processes in this embodiment of the present invention. The above described process cartridge remanufacturing method is only one of the examples of the process cartridge remanufacturing methods in accordance with the present invention. Thus, the processes and methods, in accordance with the present invention, for remanufacturing a process cartridge does not need to be limited to the above described ones. Hereinafter therefore, the above given description of the process cartridge remanufacturing method in accordance with the present invention will be supplemented in order to ensure that the present invention is correctly understood.

First, in the preceding description of the present invention, [Process for Remanufacturing Cleaning Unit] was described after [Process for Reattaching Development Roller]. This does not necessarily means that [Process for Remanufacturing Cleaning Unit] is to be carried out after [Process for Reattaching Development Roller] Since the development unit and cleaning unit are separated from each other in [Process for Separating Development Unit from Cleaning Unit], they can be discretely remanufactured, or remanufactured in parallel at the same time. Of course, the cleaning unit may be remanufactured after the development unit, or vice versa. Similarly, even if [Process for Attaching Thin Plate] is carried after [Process for Pasting Thin Elastic Sealing Member], there will be no problems.

Secondary, in the above described [Process for Refilling Toner Container with Toner], toner was filled through the opening 11i as shown in FIG. 28. Therefore, this process was carried out between [Process for Pasting Elastic Sealing member] and [Process for Reattaching Development Blade]. However, the opening through which the toner container is refilled with toner does not need to be limited to the opening 11i. For example, the toner container may be refilled with toner through the toner filling opening lid of the toner holding frame 11. In this case, toner will leak if the opening 11i is left exposed, and therefore, for the purpose of improving remanufacturing efficiency, the toner container should be refilled with toner after [Process for Reattaching Development Roller Unit].

Thirdly, the development blade and development roller unit having been removed from the development unit, and the photoconductive drum and cleaning blade having been removed from the cleaning unit, are not necessarily reattached to the very development unit and cleaning unit, respectively, from which they were removed. For example, in the case that the remanufacturing processes are carried out using the assembly line, or the like cases, all the development blades removed from the development units are gathered in units of a predetermined number and stored in a tote box or the like, are cleaned with air, and are brought to the reattachment line. Thus, a development blade is not necessarily reattached to the development unit to which it had been attached. As long as all the removed development blades belong to the same model, they are same in size and shape, admittedly that there are some differences among them resulting from predetermined tolerance. Thus, it is unnecessary for each development blade to be reattached to the original development unit. The same principle applies to the development roller unit, photoconductive drum, and cleaning blade. Further, for the same reason, even in the case of the combination of development and cleaning units, a development unit is not necessarily connected to the cleaning unit to which it originally belonged; it is unnecessary for a development unit to be connected to the cleaning unit to which it original belonged.

Further, it is needless to say that the above described various processes may be automated with the use of robots. Not only is the present invention applicable to a process cartridge, such as the above described process cartridge B, for forming a monochromatic image, but also a cartridge which is for forming a multicolor image (for example, two-toner image, three-toner image, full-color image, and the like), and which comprises a plurality of developing means 9. Regarding the charging means structure, in the above described first embodiment, the so-called contact charging method was employed. However, it is also needless to say that the structure used for uniformly charging the peripheral surface of the photoconductive drum 7 may be such a known structure that a piece of tungsten wire is shielded on three sides with a metallic shield formed of aluminum or the like, and that positive or negative ions generated by applying high voltage to the tungsten wire are transferred onto the peripheral surface of the photoconductive drum 7 to charge the photoconductive drum 7. As for the type of a charging means, the charging means may be in the form of a blade (charge blade), a pad, a block, a rod, a wire, and the like, in addition to a roller. Further, as for the means for cleaning the toner remaining on the peripheral surface of the photoconductive drum 7, it may be in the form of a blade, a fur brush, a magnetic brush, or the like.

[Structure of Brand-New Process Cartridge]

In the preceding sections, cartridge remanufacture was described. However, the above described cartridge structure arrangement is also applicable to a brand-new cartridge.

More specifically, the process cartridge B removably mountable in the main assembly of an electrophotographic image forming apparatus is structured as follows.

The process cartridge B comprises: the cleaning means holding frame 13 as a first frame for supporting the electrophotographic photoconductive drum 7; toner holding frame 11 as a second frame, which supports the development roller 9c for developing the electrostatic latent image formed on the photoconductive drum 7, and has the toner container 11A as a developer storage portion for storing the developer used by the development roller 9c of developing the electrostatic latent image; and the developing means holding frame 12 connected to the frame 13 (first frame) so that the former and latter are allowed to rotate relative each other. Further, the process cartridge B comprises: the elastic sealing member 12s2, one of the edge of which in terms of the widthwise direction is placed in contact with the peripheral surface of the development roller 9c to prevent the developer from leaking from between the frame 12 (second frame) and development roller 9c; the piece of double-sided adhesive tape 12s5, which extends in the lengthwise direction of the frame 12, and the two adhesive surfaces of which adhere to the elastic sealing member 12s2, and the frame 12 (second frame), one for one, to attach the elastic sealing member 12s2 to the frame 12 (second frame), wherein one of the edge portions of the double-sided adhesive tape 12s5, in terms of the widthwise direction, protrudes from the edge 12a (FIGS. 28, 30 and 32) of the frame 12 (second frame) toward the development roller 9c.

The distance one of the edge portions of the double-sided adhesive tape 12s5, in terms of the width direction, protrudes from the edge 12a of the frame 12 (second frame) is greater across the center portion than across the lengthwise end portions.

The preceding embodiment of the present invention includes a case in which a plurality of process cartridge, the service lives of which have expired, are recovered and disassembled; the components removed from the process cartridges through disassembly were sorted; and process cartridges are remanufactured using the sorted components, or brand-new components if necessary (in the case of nonrecyclable component) and the above described cartridge remanufacturing method. It also includes a case in which a process carriage, the service life of which has expired, is recovered and disassembled; and the process cartridge is remanufactured using the components removed the process cartridge, brand-new components if necessary (in the case of nonrecyclable component), or the components removed from the other process cartridge, and also using the above described cartridge remanufacturing method.

As described above, the present invention provides a simple method for remanufacturing a process cartridge. It also makes it possible to provide a process cartridge from which developer is not likely to leak.

While the invention has been described with reference to the structures disclosed herein, it is not confined to the details set forth and this application is intended to cover such modifications or changes as may come within the purposes of the improvements or the scope of the following claims.

What is claimed is:

1. A remanufacturing method for a process cartridge detachably mountable to a main assembly of an electrophotographic image forming apparatus, wherein said process cartridge comprises a first frame supporting an electrophotographic photosensitive drum and a second frame which supports a developing roller for developing an electrostatic latent image formed on the electrophotographic photosensitive drum and which includes a developer accommodating portion accommodating a developer to be used for development of the electrostatic latent image by the developing roller, wherein said first frame and said second frame are rotatably coupled relative to each other, said remanufacturing method comprising:
(a) a separating step of separating the first frame and the second frame from each other;
(b) a developing roller dismounting step of dismounting the developing roller mounted in the second frame;
(c) an elastic sealing member peeling step of peeling off an elastic sealing member for providing seal between the second frame and the developing roller, wherein said elastic sealing member has been stuck in a longitudinal direction of the second frame;
(d) an elastic sealing member sticking step of sticking a double coated tape on a seat on which the elastic sealing member has been stuck in a widthwise direction of the seat such that it protrudes toward the developing roller and resticking an elastic sealing member using the double coated tape;
(e) a developer filling step or filling the developer into the developer accommodating portion:
(f) a developing roller mounting step of mounting a developing roller to a second frame; and
(g) a frame coupling step of coupling separated first frame and second frame with each other.

2. A remanufacturing method for a process cartridge detachably mountable to a main assembly of an electrophotographic image forming apparatus, wherein said process cartridge comprises a first frame supporting an electrophotographic photosensitive drum and a second frame which supports a developing roller for developing an electrostatic latent image formed on the electrophotographic photosensitive drum and which includes a developer accommodating portion accommodating a developer to be used for development of the electrostatic latent image by the developing roller, wherein said first frame and said second frame are rotatably coupled relative to each other, said remanufacturing method comprising:
(a) a separating step of separating the first frame and the second frame from each other;
(b) a developing roller dismounting step of dismounting the developing roller mounted in the second frame;
(c) an elastic sealing member peeling step of peeling off an elastic sealing member for providing seal between the second frame and the developing roller, wherein said elastic sealing member has been stuck in a longitudinal direction of the second frame;
(d) a second developing roller end portion auxiliary seal mounting step of mounting a second developing roller end portion auxiliary seal along an inside of a developing roller end portion seal for sealing an end of the developing roller mounted to the second frame, al a developing roller side of a first developing roller end portion auxiliary seal which has been mounted at a position covered by sealing member, adjacent the first developing roller end portion auxiliary seal:
(e) an elastic sealing member sticking step of sticking a double coated tape on a seat on which the elastic sealing member has been stuck in a widthwise direction of the seat such that it protrudes toward the developing roller and resticking an elastic sealing member using the double coated tape;
(g) a developing roller mounting step of mounting a developing roller to a second frame; and
(h) a frame coupling step of coupling separated first frame and second frame with each other.

3. A remanufacturing method according to claim 1 or 2, further comprising a developing blade dismounting step of dismounting a developing blade from the second frame after said developing roller dismounting step, and a developing blade mounting step of mounting a developing blade to the second frame prior to said developing roller mounting step.

4. A remanufacturing method according to claim 1 or 2, wherein the elastic sealing member stuck in said elastic sealing member sticking step has a thickness which is larger than a thickness of the thin elastic sealing member which has been stuck.

5. A remanufacturing method according to claim 1 or 2, wherein a dimension of the elastic sealing member stuck in said elastic sealing member sticking step, measured in the widthwise direction, is larger than that of the thin elastic sealing member which has been stuck, and is protruded toward the developing roller.

6. A remanufacturing method according to claim 1 or 2, wherein a distance of the protrusion of the double coated tape is larger in a longitudinally central portion than longitudinally end portions.

7. A remanufacturing method according to claim 3, wherein the developing blade to be mounted to said second frame in said developing blade mounting step is the developing blade removed from the second frame of said process cartridge or a developing blade removed o from a second frame of another process cartridge.

8. A remanufacturing method according to claim 1 or 2, wherein the developing roller mounted to said second frame in said developing roller mounting step is the developing roller dismounted from the second frame of said process cartridge or a developing roller dismounted from a second frame of another process cartridge.

9. A remanufacturing method according to claim 1 or 2, wherein in said frame coupling step, said coupled frames comprises the first frame separated in said frame separating step or a first frame removed from another process cartridge, and the second frame separated in said frame separating step or a second frame removed from another process cartridge.

10. A remanufacturing method according to claim 1 or 2, wherein the electrophotographic photosensitive drum and a cleaning blade for removing the developer remaining on the electrophotographic photosensitive drum are dismounted from the first frame prior to said frame coupling step, and the developer removed from the electrophotographic photosensitive drum by the cleaning blade is removed.

11. A remanufacturing method according to claim 1 or 2, wherein the electrophotographic photosensitive drum is replaced with a new electrophotographic photosensitive drum or is reused; the developing roller is replaced with a new developing roller or is reused; the cleaning blade is replaced with a new cleaning blade or is reused.

12. A remanufacturing method according to claim 11, wherein the reused electrophotographic photosensitive drum is the electrophotographic photosensitive drum removed from the first frame of said process cartridge or is an electrophotographic photosensitive drum removed from a first frame of another process cartridge; the reused developing roller is the developing roller removed from the second frame or is a developing roller removed from a second frame of another process cartridge; and the reused cleaning blade is the cleaning blade removed from the first frame or said process cartridge or is a cleaning blade removed from a first frame of another process cartridge.

13. A remanufacturing method according to claim 1 or 2, wherein in said developer filling step, the developer is filled through a developer supply opening for supplying the developer from a developer accommodating portion to the developing roller.

14. A remanufacturing method according to claim 1 or 2, wherein in the remanufacturing, a sealing member for sealing a developer supply opening is kept pulled out to supply the developer from a developer accommodating portion to the developing roller.

15. A remanufacturing method according to claim 1 or 2, wherein in said elastic sealing member sticking step, an elastic sealing member is stuck on one side of the double coated tape, and then, the other side of the double coated tape is stuck on the seat.

16. A remanufacturing method for a process cartridge detachably mountable to a main assembly of an electrophotographic image forming apparatus, wherein said process cartridge comprises a first frame supporting an electrophotographic photosensitive drum and a second frame which supports a developing roller for developing an electrostatic latent image formed on the electrophotographic photosensitive drum and which includes a developer accommodating portion accommodating a developer to be used for development of the electrostatic latent image by the developing roller, wherein said first frame and said second frame are rotatably coupled relative to each other, said remanufacturing method comprising:
(a) a separating step of separating the first frame and the second frame from each other;
(b) a developing roller dismounting step of dismounting the developing roller mounted in the second frame;
(c) developing blade dismounting step of dismounting from second frame a developing blade for regulating an amount of the developer deposited on the developing roller mounted on the second frame;
(d) an elastic scaling member dismounting step of dismounting an elastic sealing member for sealing between the second frame and the developing roller extended in a longitudinal direction of the second frame;
(e) a sheet material mounting step of mounting a sheet material on such a side of a longitudinal seal for the developing blade for sealing between the second frame and the developing blade which has been mounted along a longitudinal direction of the second frame as is opposite the side mounted to the second frame;
(f) a second developing roller end portion auxiliary seal mounting step of mounting a second developing roller end portion auxiliary seal along an inside of a developing roller end portion seal for sealing an end of the developing roller mounted to the second frame, at a developing roller side of a first developing roller end portion auxiliary seal which has been mounted at a position covered by sealing member, adjacent the first developing roller end portion auxiliary seal;
(g) an elastic sealing member sticking step of sticking a double coated tape on a seat on which the elastic sealing member has been stuck in a widthwise direction of the seat such that it protrudes toward the developing roller and resticking an elastic sealing member using the double coated tape;
(h) a developer filling step of filling the developer into the developer accommodating portion;
(i) a developing blade mounting step of mounting, to a second frame, a sheet material and a longitudinal seal with reversed face orientation of the blade;
(j) a developing roller mounting step of mounting a developing roller to a second frame; and
(k) a frame coupling step of coupling separated first frame and second frame with each other.

17. A remanufacturing method according to claim 16, wherein the elastic sealing member stuck in said elastic sealing member sticking step has u thickness which is larger than a thickness of the thin elastic sealing member which has been stuck.

18. A remanufacturing method according to claim 16 or 17, wherein a dimension of the elastic sealing member stuck in said elastic sealing member sticking step, measured in the widthwise direction, is larger than that of the thin elastic sealing member which has been stuck, and is protruded toward the developing roller.

19. A remanufacturing method according to claim 16 or 17, wherein a distance of the protrusion of the double coated tape is larger in a longitudinally central portion than longitudinally end portions.

20. A remanufacturing method according to claim 16 or 17, wherein the developing blade to be mounted to said second frame in said developing blade mounting step is the developing blade removed from the second frame of said process cartridge or a developing blade removed from a second frame of another process cartridge.

21. A remanufacturing method according to claim 16 or 17, wherein the developing roller mounted to said second frame in said developing roller mounting step is the developing roller dismounted from the second frame of said process cartridge or a developing roller dismounted from a second frame of another process cartridge.

22. A remanufacturing method according to claim 16, wherein in said frame coupling step, said coupled frames comprises the first frame separated in said frame separating step or a first frame removed from another process cartridge, and the second frame separated in said frame separating step or a second frame removed from another process cartridge.

23. A remanufacturing method according to claim 16 or 22, wherein the electrophotographic photosensitive drum and a cleaning blade for removing the developer remaining on the electrophotographic photosensitive drum are dismounted from the first frame prior to said frame coupling step, and the developer removed from the electrophotographic photosensitive drum by the cleaning blade is removed.

24. A remanufacturing method according to claim 16, wherein the electrophotographic photosensitive drum is replaced with a new electrophotographic photosensitive drum or is reused; the developing roller is replaced with a new developing roller or is reused; the cleaning blade is replaced with a new cleaning blade or is reused.

25. A remanufacturing method according to claim 24, wherein the reused electrophotographic photosensitive drum is the electrophotographic photosensitive drum removed from the first frame of said process cartridge or is an electrophotographic photosensitive drum removed from a first frame of another process cartridge; the reused developing roller is the developing roller removed from the second frame or is a developing roller removed from a second frame of another process cartridge; and the reused cleaning blade is the cleaning blade removed from the first frame of said process cartridge or is a cleaning blade removed from a first frame of another process cartridge.

26. A remanufacturing method according to claim 16, wherein in said developer filling step, the developer is filled through a developer supply opening for supplying the developer from a developer accommodating portion to the developing roller.

27. A remanufacturing method according to claim 16, wherein in the remanufacturing, a sealing member for sealing a developer supply opening is kept pulled out to supply the developer from a developer accommodating portion to the developing roller.

28. A remanufacturing method according to claim 16 or 17, wherein in said elastic sealing member sticking step, an elastic sealing member is stuck on one side of the double coated tape, and then, the other side of the double coated tape is stuck on the seat.

29. A process cartridge detachably mountable to a main assembly of an electrophotographic image forming apparatus, comprising:
a first frame supporting an electrophotographic photosensitive drum;
a second frame which supports a developing roller for developing an electrostatic latent image formed on said photosensitive drum and which includes a developer accommodating portion for accommodating a developer to be used for development of the electrostatic latent image by the developing roller, wherein said first frame and said second frame are rotatably coupled relative to each other;
an elastic for preventing leakage of the developer through between said second frame and said developing roller with one lateral end thereof is contacted to a peripheral surface of said developing roller;
a double coated tape for sticking the elastic sealing member along a longitudinal direction of said second frame, wherein the elastic sealing member is stuck one side of the double coated tape, and the other side of the double coated tape is stuck on said second frame along the longitudinal direction of said second frame, and wherein one lateral end of the double coated tape is protruded beyond an along of said second frame toward said developing roller.

30. A process cartridge according to claim 29, wherein a distance of the protrusion of the double coated tape is larger in a longitudinally central portion than longitudinally end portions.
